(19) United States
(12) Patent Application Publication
(10) Pub. No.: US 2025/0315061 A1
(43) Pub. Date: Oct. 9, 2025

(54) INFORMATION PROCESSOR, INFORMATION PROCESSING SYSTEM, AND CONTROL METHOD OF INFORMATION PROCESSOR

(71) Applicant: HONDA MOTOR CO., LTD., Tokyo (JP)

(72) Inventors: Takahiro Oyama, Tokyo (JP); Maiko Tabata, Tokyo (JP)

(21) Appl. No.: 18/625,518

(22) Filed: Apr. 3, 2024

(51) Int. Cl. G05D 1/648; A01D 34/00; A01D 101/00; G05D 105/15

(52) U.S. Cl. CPC G05D 1/648; A01D 34/008; A01D 2101/00; G05D 2105/15

(57) ABSTRACT

A display terminal control unit of an information processor displays a work area image indicating a position of a work area and a status of the work area in a superimposed manner on a map image based on acquired information, and the status includes a work completion status corresponding to a condition during a predetermined period from a work completion timing at which a predetermined work for the work area has been completed, and a work required status corresponding to a condition that requires the work after the predetermined period has elapsed.

### BACKGROUND OF THE INVENTION

### Field of the Invention

The present invention relates to an information processor, an information processing system and a control method of the information processor.

### Description of the Related Art

Autonomous traveling work machine that travels in a work area and automatically performs a work has emerged. Japanese Patent No. 6872189 discloses autonomous traveling work machine that cleans a floor surface of one or more cleaning areas (work areas) by storing data of traveling routes, and the like, and a control device of the autonomous traveling work machine. The control device notifies a user (operator) of a plan that is a combination of a traveling route and work setting.

Meanwhile, the autonomous traveling work machine disclosed in Japanese Patent No. 6872189 is directed to a technique related to work machine that cleans a floor surface indoors or inside a room sectioned by a wall, and the like, and is not directed to a technique that supports works, such as a lawn cutting work and an outdoor cleaning work, which are performed in an outdoor large area for a longer period of time.

Thus, even if an attempt is made to apply the technique disclosed in Japanese Patent No. 6872189 to outdoor as it is, the technique is still insufficient to allow a user to easily grasp a location of a work area in which a work is to be performed and a current condition of the work area. For example, in a case where the work area is an outdoor extensive area or there are a number of areas, it requires time and effort to perform a work of grasping each work area.

An object of the present invention, which has been made in view of the above-described circumstances, is to displaying a location and a condition of a work area in which a work is to be performed in an easily understandable manner.

### SUMMARY OF THE INVENTION

An information processor is provided, the information processor including a display terminal control unit that displays a map image on a display unit and acquires information regarding one or more work areas, the display terminal control unit displaying a work area image indicating a position of the work area and a status of the work area in a superimposed manner on the map image based on the acquired information, and the status including a work completion status corresponding to a condition during a predetermined period from a work completion timing at which a predetermined work for the work area has been completed, and a work required status corresponding to a condition that requires the work after the predetermined period has elapsed.

According to an aspect of the present invention, it is possible to display a location and a condition of a work area in which a work is to be performed in an easily understandable manner.

### BRIEF DESCRIPTION OF THE DRAWINGS

FIG. 1 is a schematic view of an information processing system according to an embodiment of the present invention;

FIG. 2 is a block diagram illustrating a configuration of autonomous traveling work machine;

FIG. 3 is a block diagram illustrating a configuration of a server device;

FIG. 4 is a block diagram illustrating a configuration of an operation device;

FIG. 5 is a view illustrating one example of a display screen on which a map image is being displayed;

FIG. 6 is a view illustrating one example of a work area image;

FIG. 7 is a view illustrating one example of an autonomous traveling work machine image;

FIG. 8 is a view illustrating a display example of an operation device related to teaching;

FIG. 9 is a view illustrating a display example continued from FIG. 8;

FIG. 10 is a view illustrating a display example continued from FIG. 9;

FIG. 11 is a view illustrating a display example continued from FIG. 10;

FIG. 12 is a view illustrating a display example of the operation device related to teaching;

FIG. 13 is a view illustrating a display example continued from FIG. 12;

FIG. 14 is a view illustrating a display example continued from FIG. 13;

FIG. 15 is a view illustrating a display example of the operation device related to playback;

FIG. 16 is a view illustrating a display example continued from FIG. 15;

FIG. 17 is a view illustrating a display example continued from FIG. 16;

FIG. 18 is a view illustrating a display example continued from FIG. 17;

FIG. 19 is a view illustrating a display example continued from FIG. 18;

FIG. 20 is a view illustrating another example of the work area image;

FIG. 21 is a view illustrating another example of the work area image; and

FIG. 22 is a view illustrating a modification of a display screen Gc3 in FIG. 15.

### DETAILED DESCRIPTION OF THE PREFERRED EMBODIMENT

An embodiment of the present invention will be described below with reference to the drawings.

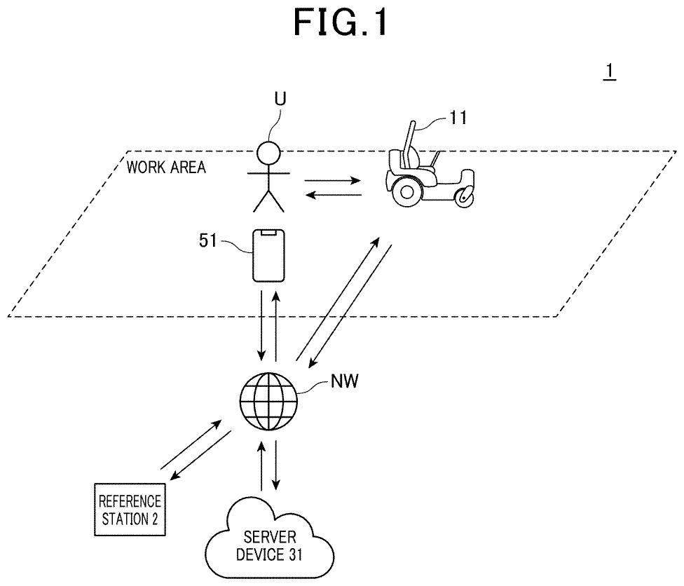

FIG. 1 is a schematic view of an autonomous traveling work system 1 according to the embodiment of the present invention.

The autonomous traveling work system 1 includes autonomous traveling work machine 11, a server device 31, and an operation device 51. While the number of the autonomous traveling work machines 11 and the number of the operation devices 51 are not particularly limited, in the present embodiment, a plurality of the autonomous traveling work machines 11 and a plurality of the operation devices 51 are used by a plurality of people.

Note that an operator who operates the autonomous traveling work machine 11 may be the same as or different from an operator who operates the operation device 51. In the present description, the respective operators will be collectively expressed as a user U. The autonomous traveling work system 1 is one example of an “information processing system” of the present invention.

The respective the autonomous traveling work machines 11 and the respective operation devices 51 may be shared by a plurality of users U, or there may be a one-to-one relationship between the operation devices 51 and the users U. The autonomous traveling work machine 11, which is autonomous traveling work machine having an autonomous traveling function and a function of performing a predetermined work in a work area, in the present embodiment, is a riding-type automatic lawn mower that performs a lawn cutting work in an outdoor work area. The autonomous traveling work machine 11 is also referred to as an autonomous work mower (AWM). Note that the autonomous traveling work machine 11 of the present invention is not limited to a lawn mower and may be, for example, an autonomous traveling type cleaning truck that cleans outdoor, an autonomous traveling type sprinkler truck that sprinkles water on a green area, and the like, or a snow-plow truck that performs a snow removal work in an area in which snow is to be removed.

The autonomous traveling work machine 11, the server device 31, and the operation device 51 can perform communication with each other via a network NW including the Internet and mobile wireless communication. The autonomous traveling work machine 11 has a function of accurately determining a current position by utilizing a real-time kinematic global navigation satellite system (RTK-GNSS) which is one of high-accuracy positioning techniques.

In the RTK-GNSS, a reference station (base station) 2 stores known positions and generates correction data of the GNSS within a predetermined geographical range in real time using position data of the known positions and a signal from a satellite. A mobile station (corresponding to the autonomous traveling work machine 11) that determines a position receives the correction data from the reference station 2 and corrects a signal from the GNSS satellite with the correction data, so that accuracy of the current position is improved. The GNSS satellite is, for example, a GPS satellite.

Note that the positioning method is not limited to a method utilizing the RTK-GNSS, and a method utilizing a publicly known positioning technique with which position data with required accuracy can be obtained can be widely applied.

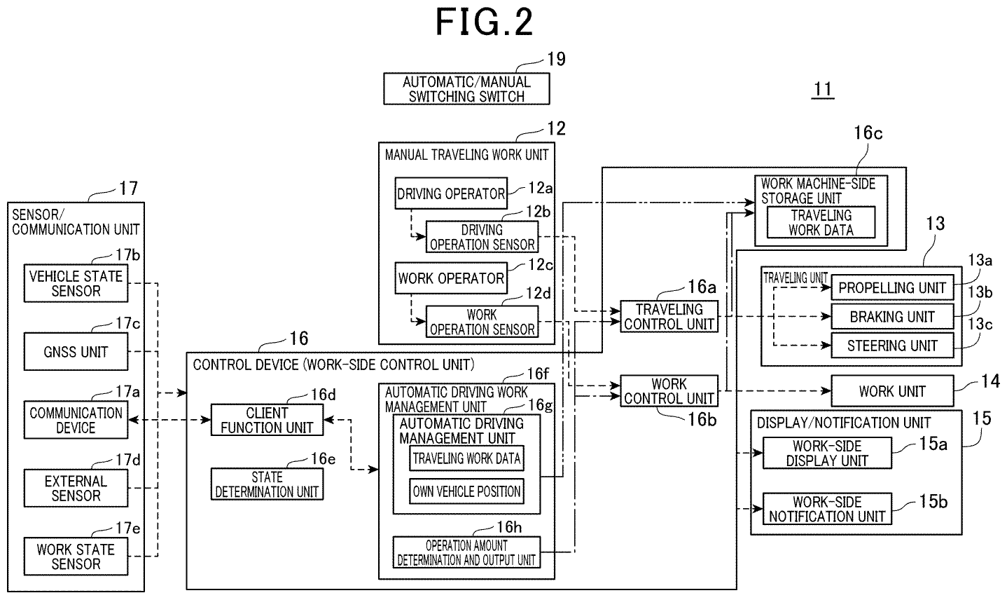

FIG. 2 is a block diagram illustrating a configuration of the autonomous traveling work machine 11.

The autonomous traveling work machine 11 includes a manual traveling work unit 12, a traveling unit 13, a work unit 14, a display/notification unit 15, a control device 16, a sensor/communication unit 17, and an automatic/manual switching switch 19.

The manual traveling work unit 12, which is a component for allowing the user U to manually drive the autonomous traveling work machine 11, includes a driving operator 12a that performs operation regarding traveling of the autonomous traveling work machine 11, a driving operation sensor 12b that detects operation of the driving operator 12a, a work operator 12c that performs operation regarding a work of the autonomous traveling work machine 11, and a work operation sensor 12d that detects operation of the work operator 12c.

The traveling unit 13 includes a propelling unit 13a that propels the autonomous traveling work machine 11, a braking unit 13b that brakes the autonomous traveling work machine 11, and a steering unit 13c that swirls the autonomous traveling work machine 11. The propelling unit 13a is, for example, a drive source such as a motor that rotates right and left wheels of the autonomous traveling work machine 11, and the braking unit 13b is a brake device that brakes the right and left wheels. The steering unit 13c has a component that swirls the autonomous traveling work machine 11. Note that in a case of a configuration where the autonomous traveling work machine 11 is made to swirl by a difference in rotation of the right and left wheels (such as a so-called zero turn radius (ZTR)-type lawn mower), the propelling unit 13a is also used as the steering unit 13c.

The work unit 14, which is a component for performing a lawn cutting work, includes a blade for lawn cutting in the present embodiment. Note that in a case where the autonomous traveling work machine 11 is an autonomous traveling type cleaning truck, the work unit 14 includes a cleaning unit such as a brush and a suction unit, in a case where the autonomous traveling work machine 11 is an autonomous traveling type sprinkler truck, the work unit 14 includes a sprinkling unit such as a nozzle, and in a case where the autonomous traveling work machine 11 is a snow-plow truck, the work unit 14 includes an auger.

The display/notification unit 15 includes a work-side display unit 15a that displays various kinds of information, and a work-side notification unit 15b that makes a notification of various kinds of information. The work-side display unit 15a is, for example, an indicator that is visually confirmed by the user U who operates the autonomous traveling work machine 11, and the work-side notification unit 15b includes, for example, a lamp that displays various kinds of information by display and a speaker that makes a notification of various kinds of information by speech.

The work-side notification unit 15b is not limited to components (for example, a lamp and a speaker) that notify the user U who operates the autonomous traveling work machine 11 of information and may include a component (for example, a warning lamp) that notifies peoples around the autonomous traveling work machine 11 of an operating state of the autonomous traveling work machine 11 (for example, whether or not the autonomous traveling work machine 11 is performing teaching or playback).

The control device 16 functions as a work-side control unit that controls the autonomous traveling work machine 11. The control device 16 includes a computer including a processor that controls the autonomous traveling work machine 11, a peripheral circuit, a memory that stores data such as a program, and the like, and by the processor executing the program stored in the memory, a traveling control unit 16a, a work control unit 16b, a work machine-side storage unit 16c, and the like, corresponding to the autonomous traveling work system 1 are implemented. Note that the configuration is not limited to the configuration where the traveling control unit 16a, and the like, are implemented by software processing, and the traveling control unit 16a, and the like, may be implemented by hardware.

The traveling control unit 16a is a portion that controls the traveling unit 13, and more specifically, receives input of operation of the driving operator 12a via the driving operation sensor 12b and controls the propelling unit 13a, the braking unit 13b and the steering unit 13c in accordance with the operation of the driving operator 12a. The work control unit 16b is a portion that controls the work unit 14, and more specifically, receives input of operation of the work operator 12c via the work operation sensor 12d and controls the work unit 14 in accordance with the operation of the work operator 12c. This makes it possible to perform a lawn cutting work through manual driving by the user U.

The work machine-side storage unit 16c is a region where data such as a program is to be stored, and the data to be stored includes traveling work data for performing playback control of the autonomous traveling work machine 11. The traveling work data is data with which a work performed by manually driving of the autonomous traveling work machine 11 can be reproduced and can also be said as teaching data.

More specifically, the traveling work data is data recording a traveling route, a control state of respective units of a driving unit and the work unit 14, and the like, when the user U drives the autonomous traveling work machine 11 to perform a lawn cutting work, in a reproducible manner. The playback control is control of automatically driving the autonomous traveling work machine 11 to reproduce the work by manual driving based on the traveling work data.

The control device 16 further includes a client function unit 16d, a state determination unit 16e, and an automatic driving work management unit 16f. Further, the sensor/communication unit 17 includes a communication device 17a, a vehicle state sensor 17b, a GNSS unit 17c, an external sensor 17d, and a work state sensor 17e.

The communication device 17a includes a communication module for wireless communication and implements a function of communicating with the server device 31, the operation device 51, and the like, via the network NW such as the Internet. The client function unit 16d of the control device 16 performs processing necessary for functioning as a client of the server device 31 by communicating with the server device 31 by utilizing the communication device 17a. Further, the client function unit 16d receives an instruction from the operation device 51 and performs processing corresponding to the instruction.

The vehicle state sensor 17b, which is a sensor that detects a state of each unit of the autonomous traveling work machine 11, includes, for example, a vehicle speed sensor that detects a rotation speed of a drive wheel of the autonomous traveling work machine 11, a yaw rate sensor that detects a yaw rate of the autonomous traveling work machine 11, an inclination sensor that detects an inclination angle in a vertical direction of the autonomous traveling work machine 11, and the like.

The GNSS unit 17c functions as a position detection unit that detects a position of the autonomous traveling work machine 11. The GNSS unit 17c includes a GNSS receiver and an RTK receiver. The GNSS unit 17c receives by the GNSS receiver, satellite signals transmitted from a plurality of GNSS satellites and generates GNSS data from the satellite signals. The GNSS data includes, for example, identification numbers of the respective satellites from which the satellite signals are received, and values indicating elevation angles, azimuths, and received strength. The GNSS unit 17c receives correction data by the RTK receiver and corrects a positioning result by the GNSS receiver based on the correction data. Position data indicating a current position including information on latitude, longitude and altitude is acquired through high-accuracy positioning by the RTK-GNSS. Use of the RTK-GNSS enables positioning with accuracy with an error of a few centimeters.

The external sensor 17d, which is a sensor that detects an object existing around the autonomous traveling work machine 11, is, for example, at least one of a radar, a Lidar sensor, an ultrasonic sensor or a camera.

The work state sensor 17e, which is a sensor that detects a state of the work unit 14, is, for example, a rotation speed sensor, or the like, that detects a rotation speed of the blade included in the work unit 14.

The client function unit 16d of the control device 16 performs processing necessary for functioning as a client of the server device 31 by communicating with the server device 31 by utilizing the communication device 17a. Further, the client function unit 16d receives an instruction from the operation device 51 and performs processing corresponding to the instruction.

The state determination unit 16e determines a state of the autonomous traveling work machine 11 based on a detection result of each sensor and a communication result of the communication device 17a and performs, for example, processing of detecting a work completion timing and an operation mode (whether during teaching or during playback, or not), processing of detecting whether or not the autonomous traveling work machine 11 is in an abnormal state, for example, processing of detecting whether or not the autonomous traveling work machine 11 is traveling on a steep slope or detecting existence of an obstacle around the autonomous traveling work machine 11. Further, the state determination unit 16e can detect that the autonomous traveling work machine 11 is in an abnormal state including a system error state or can detect that an energy state of an energy source of the autonomous traveling work machine 11 is lower than a predetermined value. The energy source of the present embodiment is a storage battery that stores electric power, but the energy source may be a fuel tank, or the like, in which a fuel is accumulated.

An automatic driving work management unit 16f of the control device 16 manages data necessary for automatic driving of the autonomous traveling work machine 11. The automatic driving work management unit 16f includes an automatic driving management unit 16g and an operation amount determination and output unit 16h. The automatic driving management unit 16g acquires traveling work data from the work machine-side storage unit 16c or the server device 31 and acquires position data (own vehicle position) regarding the current position located by the RTK-GNSS. The operation amount determination and output unit 16h determines operation amounts of the traveling unit 13 and the work unit 14 so as to reproduce control states of the respective units of the traveling unit 13 and the work unit 14 based on the traveling route recorded in the traveling work data acquired by the automatic driving management unit 16g and outputs signals corresponding to the operation amounts to the traveling control unit 16a and the work control unit 16b. The operation amount determination and output unit 16h accurately reproduces the traveling route by utilizing the position data (own vehicle position) regarding the current position located by the RTK-GNSS. The automatic/manual switching switch 19 is a switch for switching a mode to a manual driving mode.

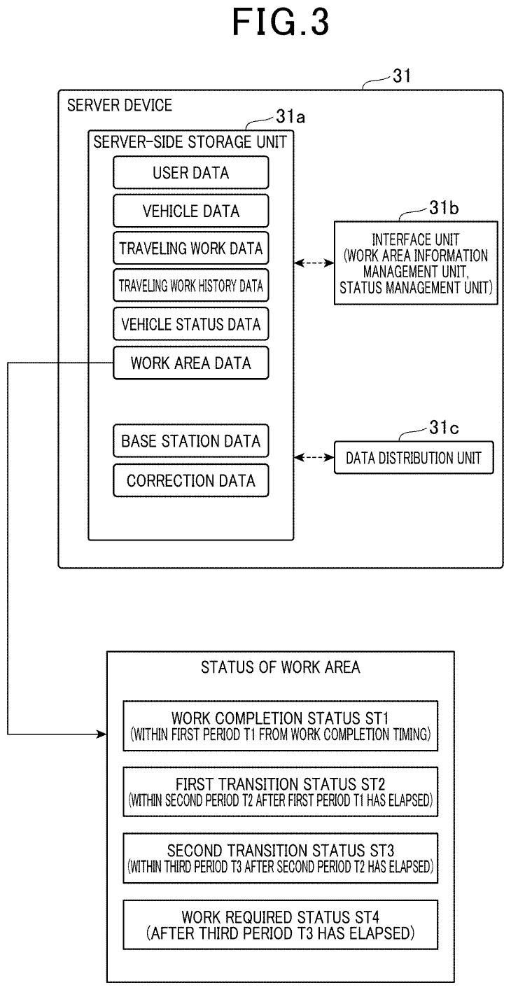

FIG. 3 is a block diagram illustrating a configuration of the server device 31.

The server device 31 includes a computer including a processor, a peripheral circuit, a memory that stores data such as a program, and the like, and by the processor executing the program, a server-side storage unit 31a, an interface unit 31b and a data distribution unit 31c corresponding to the autonomous traveling work system 1 are implemented. The server-side storage unit 31a includes, for example, a database management system (DBMS), a key-value store (KVS)-type database, and the like. The interface unit 31b includes, for example, a web server, and more specifically, includes an application programming interface (API) server, and the like. Note that the configuration is not limited to a configuration where the interface unit 31b, and the like, are implemented by software processing, and the interface unit 31b, and the like, may be implemented by hardware.

The server-side storage unit 31a stores user data, vehicle data, traveling work data, traveling work history data, vehicle status data, work area data, base station data, correction information data, and the like. The user data, which is data regarding users of the autonomous traveling work machine 11 and the operation device 51, includes a user name and account data of the user U. The vehicle data, which is data regarding the autonomous traveling work machine 11, includes, for example, identification data of each autonomous traveling work machine 11, position data indicating a current position of each autonomous traveling work machine 11, and a remaining amount of energy of the autonomous traveling work machine 11. The traveling work data is accumulated in the server device 31 by being transmitted from the autonomous traveling work machine 11. The traveling work history data includes use history of the traveling work data, a battery consumption amount for each piece of the traveling work data, and the like. The use history of the traveling work data is, for example, data with which the user U who has used playback, the number of times of use, and information regarding a success or a failure of the playback can be identified.

The vehicle status data is data with which a current status of each autonomous traveling work machine 11 can be identified.

The work area data is data that manages a position and a range of the work area, and a status of the work area.

The interface unit 31b is a function unit that causes the server device 31 to function as a web server, an API server, and the like. The interface unit 31b has a communication function of communicating with at least the autonomous traveling work machine 11 and the operation device 51, and a control function of performing control regarding communication and performs data storage in a data storage unit, data update, and the like.

Further, the interface unit 31b also functions as a status management unit that sets a status of each autonomous traveling work machine 11 based on information transmitted from each autonomous traveling work machine 11. More specifically, the interface unit 31b sets a status indicating the operation mode (during teaching, during playback) of the autonomous traveling work machine 11, a status indicating that the autonomous traveling work machine 11 is in an abnormal state (such as a system error state, a traveling impossible state due to influence of an obstacle, and the like), a status indicating that the autonomous traveling work machine 11 is in a low energy state, and the like, based on the information indicating the state, and the like, detected by the state determination unit 16e of each autonomous traveling work machine 11 and stores the statuses in the server-side storage unit 31a in association with the autonomous traveling work machine 11.

Further, the interface unit 31b functions as a work area information management unit of a position, a range, and the like, of the work area data and also functions as a status management unit that sets a status of each work area based on the information transmitted from each operation device 51 and each autonomous traveling work machine 11.

More specifically, the interface unit 31b acquires information regarding a work completion timing at which a lawn cutting work has been completed from each autonomous traveling work machine 11 and sets a status based on each work completion timing for each work area. In this case, the interface unit 31b sets the status to a work completion status ST1 within a first period T1 determined in advance from the work completion timing, automatically updates the status to a first transition status ST2 within a second period T2 after the first period T1 has elapsed, automatically updates the status to a second transition status ST3 within a third period T3 after the second period T2 has elapsed, and automatically updates the status to a work required status ST4 after the third period T3 has elapsed. Further, the status is automatically updated to the work completion status ST1 by completion of teaching and playback lawn cutting. Note that the status of the work area may be updated by batch processing that is periodical such as every night. Display may be controlled on an application side of the operation device 51.

The respective periods T1 to T3 may be set as appropriate in view of a growth speed of lawn and a suitable timing for caring lawn. For example, the respective periods T1 to T3 are preferably set based on at least one of a region of the work area, a season, a requirement for each region or individual factors for each region. In this case, a period setting table that associates at least one of the region, season, requirements for each region or individual factors for each region with the respective periods T1 to T3 is created and stored in the server-side storage unit 31a. Further, the interface unit 31b that functions as a status management unit may determine the respective periods T1 to T3 for each work area based on the period setting table stored in the server-side storage unit 31a. Further, the respective periods T1 to T3 may be able to be customized (setting can be changed) as appropriate by the user U, or the like.

The interface unit 31b notifies the operation device 51 of the respective statuses, and the like, of the autonomous traveling work machine 11 and the work area by transmitting respective pieces of data stored in the server-side storage unit 31a as appropriate in response to a request from the operation device 51.

The base station data includes a high-accuracy GNSS position of the reference station 2 (base station) and position data indicating a relatively low-accuracy position by the GNSS satellite from which data is currently being received. The correction data is correction data to be used for the RTK-GNSS and is data generated from two pieces of the position data of the reference station 2.

The data distribution unit 31c performs distribution processing of distributing the base station data and the correction data to the autonomous traveling work machine 11, and the like. Note that the interface unit 31b and the data distribution unit 31c can be also said as a server-side control unit that controls the server device 31.

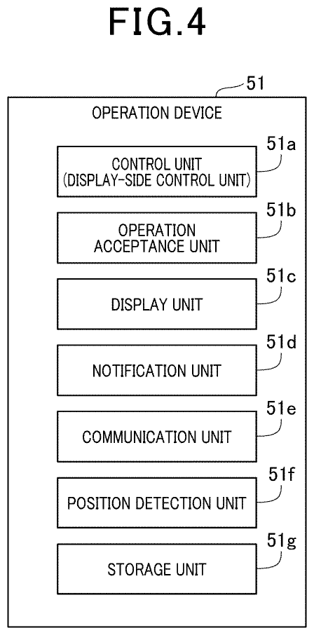

FIG. 4 is a block diagram illustrating a configuration of the operation device 51.

The operation device 51, which is an operation device to be operated by the user U, is constituted by a terminal device that can perform wireless communication such as a smartphone, a tablet and a personal computer. The operation device 51 includes a computer including a processor that controls the operation device 51, a peripheral circuit, a memory that stores data such as a program, and the like, and by the processor executing the program, a control unit 51a, an operation acceptance unit 51b, a display unit 51c, a notification unit 51d, a communication unit 51e, a position detection unit 51f, and a storage unit 51g corresponding to the autonomous traveling work system 1 are implemented. Note that the configuration is not limited to a configuration where the control unit 51a, and the like, are implemented by software processing, and the control unit 51a, and the like, may be implemented by hardware. The operation device 51 is one example of an “information processor” of the present invention.

The program stored in the storage unit 51g includes a program of a map application corresponding to the autonomous traveling work system 1. The control unit 51a performs display of a map image, or the like, by executing the program of the map application.

The operation acceptance unit 51b includes a publicly known input device such as a touch panel, an operation switch and a microphone and accepts operation by the user U of the operation device 51. The display unit 51c includes a display panel such as a liquid crystal display and displays various kinds of information. The notification unit 51d includes a lamp that displays various kinds of information by display and a speaker that makes a notification of various kinds of information by speech.

The communication unit 51e includes a communication module for wireless communication and implements function of performing communication with the server device 31, the autonomous traveling work machine 11, and the like, via the network NW such as the Internet. The program of the map application described above is, for example, a program downloaded from a predetermined server via the Internet.

The position detection unit 51f detects a position of the operation device 51 by utilizing a publicly known sensor such as a GPS sensor. Note that the position detection unit 51f may include a GNSS unit similar to the GNSS unit 17c described above and may be able to determine a current position with high accuracy.

The storage unit 51g stores various kinds of data such as a program including the map application.

The map application provides to the control unit 51a, a function of acquiring and displaying map data and a function of acquiring, displaying, and the like, information regarding the autonomous traveling work machine 11.

In the present embodiment, the control unit 51a executes the map application, thereby acquiring map data including a map image from a map server (not illustrated) that provides map information by utilizing the communication unit 51e and displaying the map image. Further, the control unit 51a can display the autonomous traveling work machine 11 and the work area existing within an area corresponding to the displayed map image in a superimposed manner on the map image and can display the statuses of the autonomous traveling work machine 11 and the work area in a superimposed manner on the map image by acquiring the data stored in the server-side storage unit 31g of the server device 31.

Further, the map application accepts selection operation of the work area and selection operation of the autonomous traveling work machine 11 from the user U by utilizing the operation acceptance unit 51b and provides a function of instructing the autonomous traveling work machine 11 selected by utilizing the communication unit 51e to perform a work of the selected work area.

The map data is data collected using an appropriate method such as a satellite image, an aero photo and topographical survey, and publicly known map data can be employed. Note that the control unit 51a of the operation device 51 is one example of a “display terminal control unit” of the present invention.

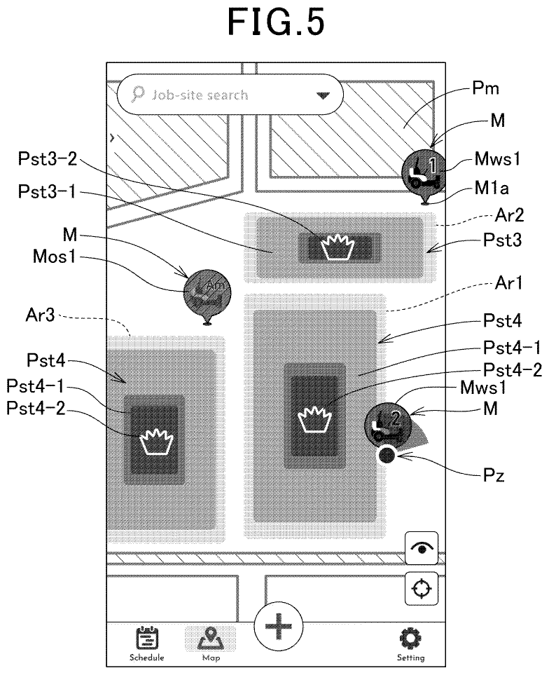

FIG. 5 illustrates one example of a display screen in which the map image is being displayed in the operation device 51. The map image in the display screen is indicated with a reference numeral Pm and indicated as a map image Pm as appropriate. Further, description will be provided while reference numerals are assigned to the work area, and the like, as appropriate.

FIG. 5 illustrates a case where three work areas Ar1, Ar2 and Ar3 and three the autonomous traveling work machines 11 exist in a display area of the map image Pm.

In the display screen, three work area images Pst respectively indicating the work areas Ar1, Ar2 and Ar3 and three autonomous traveling work machine images M (hereinafter, described as “work machine images M”) respectively indicating the respective the autonomous traveling work machines 11 are displayed in a superimposed manner on the map image Pm.

Further, in the display screen, an image (user position image) Pz indicating the position of the operation device 51 is also displayed in a superimposed manner on the map image, and an operation image for graphical user interface (GUI) is also displayed. The operation acceptance unit 51b includes a touch panel and accepts user operation of the operation image for GUI via the touch panel. This allows the user U to move the map image Pm (change a display range of the map), for example, by performing dragging operation on the map image Pm and to increase and decrease a size of the map image Pm by performing pinch operation on the map image Pm.

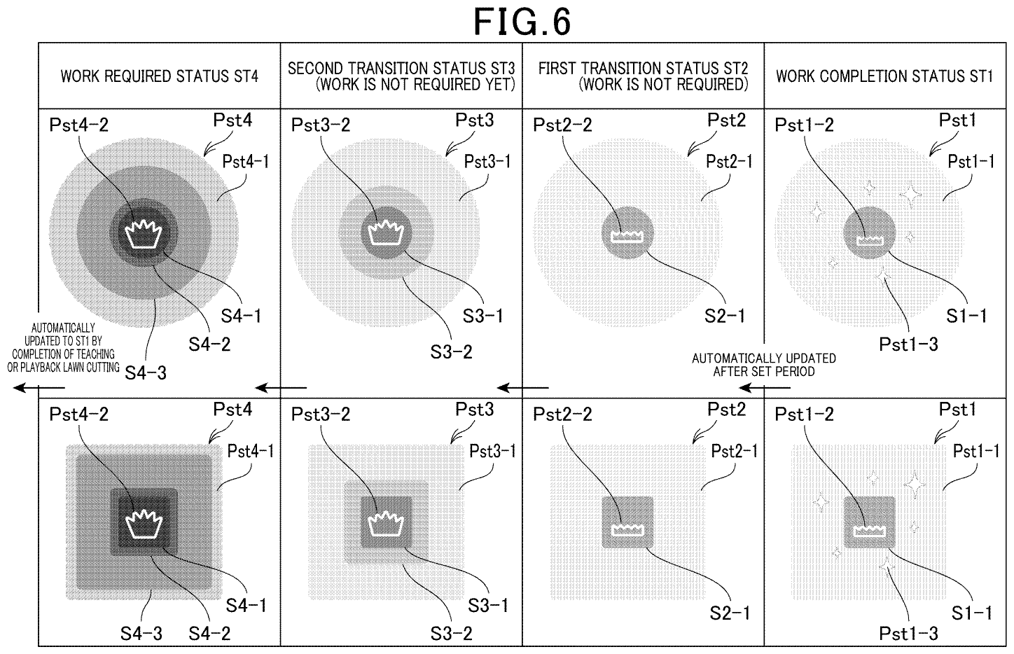

FIG. 6 is a view illustrating one example of the work area image Pst.

The work area image Pst is set for each status of the work area, and in the present embodiment, the work area images are respectively set for the work completion status ST1, the first transition status ST2, the second transition status ST3, and the work required status ST4.

The work area image Pst1 corresponding to the work completion status ST1 includes an area display element Pst1-1 indicating a position of the work area, and an area status display element Pst1-2 indicating a status of the work area.

The work area image Pst2 corresponding to the first transition status ST2 includes an area display element Pst2-1 indicating a position of the work area and an area status display element Pst2-2 indicating a status of the work area.

The work area image Pst3 corresponding to the second transition status ST3 includes an area display element Pst3-1 indicating a position of the work area and an area status display element Pst3-2 indicating a status of the work area.

The work area image Pst4 corresponding to the work required status ST4 includes an area display element Pst4-1 indicating a position of the work area and an area status display element Pst4-2 indicating a status of the work area.

As illustrated in FIG. 5, as a result of the work area images Pst being displayed in a superimposed manner on positions of the work areas Ar1 to Ar3 of the map image Pm, the user U can easily visually confirm the positions of the work areas Ar1 to Ar3.

In FIG. 6, an upper part illustrates the work area images Pst (Pst1 to Pst4) in a case where the work areas have a circular shape, and a lower part illustrates the work area images Pst (Pst1 to Pst4) in a case where the work areas have a rectangular shape.

In the present embodiment, work area contour images whose outlines match contours of the work areas are displayed as the area display elements Pst1-1, Pst2-1, Pst3-1 and Pst4-1. This allows the user U to easily visually confirm positions and shapes of the work areas.

Further, images which simulate lawn and which have different lengths of the lawn are displayed in accordance with the statuses of the work areas as the area status display elements Pst1-2, Pst2-2, Pst3-2 and Pst4-2. In other words, states of gradually grown lawn can be indicated in ascending order of the length from the work completion status ST1, the first transition status ST2 (a work is not required), the second transition status ST3 (a work is not required yet), and the work required status ST4. Thus, the user U can determine whether or not lawn cutting is required by the area status display elements Pst1-2, Pst2-2, Pst3-2 and Pst4-2. In other words, whether or not the work is required in the work area can be easily grasped.

As illustrated in FIG. 6, in the present embodiment, as the work area contour images that are the area display elements Pst1-1, Pst2-1, Pst3-1 and Pst4-1, images with different transparency in accordance with the statuses of the work areas are employed. More specifically, the transparency of the work area contour images gradually decreases in order of the work completion status ST1, the first transition status ST2, the second transition status ST3 and the work required status ST4. By decreasing the transparency, the work area can be indicated as having darker color, that is, as a state where lawn is grown. This also allows the user U to determine whether or not lawn cutting is required, and the like, and easily grasp a state regarding a work in the work area.

Further specifically, one or more figures S (S1-1, S2-1, S3-1, S3-2, S4-1, S4-2 and S4-3) that are concentric circles or concentric rectangles expanding outward from the center are set within the work area contour images that are the area display elements Pst1-1, Pst2-1, Pst3-1 and Pst4-1. These figures S are set to increase in the number, and shapes of the increased figures S become larger (have larger diameters) in order of the area display elements Pst1-1, Pst2-1, Pst3-1 and Pst4-1. Further, the transparency becomes lower and the color become darker toward the inner periphery, and the transparency becomes higher toward the outer periphery at the outlines of the respective figures S as boundaries.

By this means, as illustrated in FIG. 6, an area where transparency of the work area image Pst is low increases, that is, the work area indicates a state as if the lawn were grown in order from the work completion status ST1, the first transition status ST2, the second transition status ST3 and the work required status ST4. Moreover, transparency around at least the outer periphery of the work area image Pst can be maintained to be high enough so that the map image can be visually confirmed, and thus, it is possible to prevent decrease in a display area of the map image and decrease in the map information.

Further, by decreasing transparency and making the color darker around the area status display elements Pst1-2, Pst2-2, Pst3-2 and Pst4-2 by the figures S (S1-1, S2-1, S3-1, S3-2, S4-1, S4-2 and S4-3) on the inner periphery side, it is possible to provide stronger impression that the lawn is grown.

Note that the change pattern of the figure S illustrated in FIG. 6 is one example, and the change pattern can be changed as appropriate as long as the work area for which a work is required can be easily visually confirmed while decrease in the map information can be prevented. Further, the shape, and the like, of the figure S may be changed as appropriate.

As illustrated in FIG. 6, in the present embodiment, in a case of the work completion status ST1, a decorative image Pst1-3 that emphasizes that the lawn has just been cut is added to the work area image Pst1. The decorative image Pst1-3 allows the user U to more easily recognize that the lawn has just been cut. In other words, the decorative image Pst1-3 functions as one of the area status display elements indicating a status (work completion status ST1) of the work area.

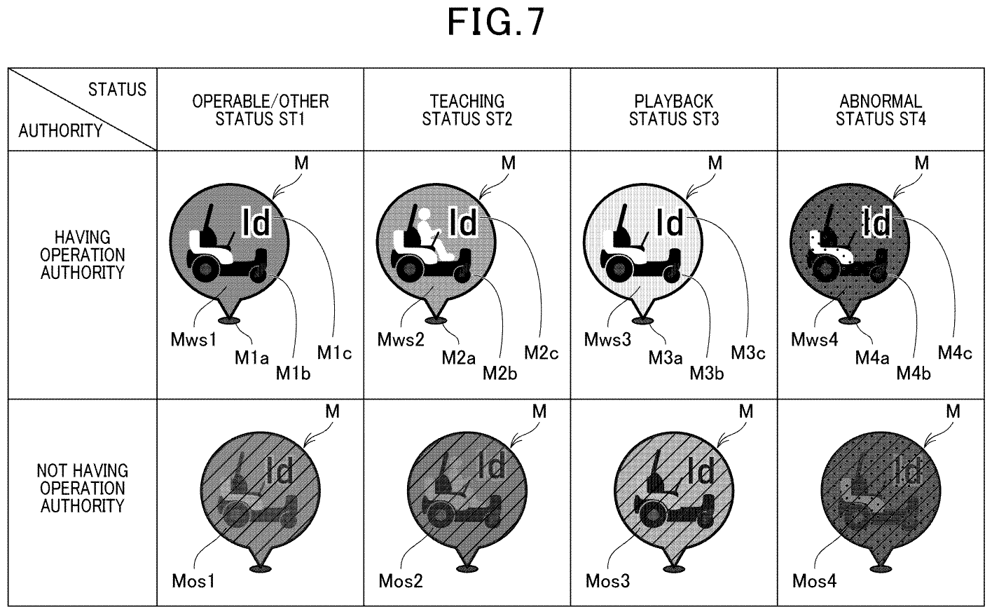

FIG. 7 is a view illustrating one example of the work machine image M. In FIG. 7, an upper part illustrates a case of the autonomous traveling work machine 11 for which the user U of the operation device 51 has operation authority (authority regarding operation), and a lower part illustrates a case of the autonomous traveling work machine 11 for which the user U of the operation device 51 does not have operation authority.

In other words, in the present embodiment, one or more autonomous traveling work machines 11 for which the user U has operation authority are set for each user U, in other words, one or more users U having operation authority are set for each autonomous traveling work machine 11. Whether or not the operation authority is provided is described in vehicle data managed by the server device 31 and/or user data. In the operation device 51, the work machine image M is generated based on whether or not the operation authority for the autonomous traveling work machine 11 is provided included in the information transmitted from the server device 31.

In a case of the autonomous traveling work machine 11 for which the user U has operation authority, as illustrated in the upper part of FIG. 7, the work machine image M is set for each status of the autonomous traveling work machine 11, and in the present embodiment, the work machine image is set for each of an operable/other status ST1, a teaching status ST2, a playback status ST3 and an abnormal status ST4 including a system error state. Note that in the present embodiment, a state of the operable/other status ST1 corresponds to a state where the autonomous traveling work machine 11 is available for playback, teaching, and the like, and can be also said as an “available state”.

The work machine image M corresponding to the operable/other status ST1 includes a position image Mla indicating a position of the autonomous traveling work machine 11, an appearance image M1b of the autonomous traveling work machine 11, and a machine identification image M1c of the autonomous traveling work machine 11.

The work machine image M corresponding to the teaching status ST2 includes a position image M2a indicating a position of the autonomous traveling work machine 11, an appearance image M2b of the autonomous traveling work machine 11, and a machine identification image M2c of the autonomous traveling work machine 11.

The work machine image M corresponding to the playback status ST3 includes a position image M3a indicating a position of the autonomous traveling work machine 11, an appearance image M3b of the autonomous traveling work machine 11 and a machine identification image M3c of the autonomous traveling work machine 11.

The work machine image M corresponding to the abnormal status ST4 includes a position image M4a indicating a position of the autonomous traveling work machine 11, an appearance image M4b of the autonomous traveling work machine 11 and a machine identification image M4c of the autonomous traveling work machine 11.

As illustrated in FIG. 5, by the work machine image M being displayed in a superimposed manner in the vicinity of the position of the autonomous traveling work machine 11 on the map image Pm, the user U can easily visually confirm the position of the autonomous traveling work machine 11. The machine identification images M1c to M4c are information based on identification data of vehicles stored in the server device 31 and, for example, are information indicating vehicle numbers and vehicle names (including initial letters and abbreviated names). The work machine image M allows the user U to easily visually confirm the position of the autonomous traveling work machine 11 and identify the autonomous traveling work machine 11.

In the present embodiment, a background color of the appearance image M1b and the machine identification image M1c is changed to colors Mws1, Mws2, Mws3 and Mws4 different from each other in accordance with the statuses of the autonomous traveling work machine 11, that is, in accordance with the operable/other status ST1, the teaching status ST2, the playback status ST3 and the abnormal status ST4 including the system error state. By this means, the background color changes in accordance with whether the status of the autonomous traveling work machine 11 is the operable/other status ST1, the teaching status ST2, the playback status ST3 or the abnormal status ST4 including the system error state, so that the status of the autonomous traveling work machine 11 can be discerned by a difference in the background color.

In other words, the background colors Mws1 to Mws4 of the appearance images M1b to M4b and the identification images M1c to M4c function as autonomous traveling work machine status display elements indicating the statuses of the autonomous traveling work machine 11.

The background colors Mws1 to Mws4 corresponding to the respective statuses are not particularly limited, but, for example, by making the background color red in an abnormal state, white during playback, orange during teaching, and blue in an “operable/other” state, the user U of the operation device 51 can easily recognize the state of the autonomous traveling work machine 11.

Note that the method is not limited to a method in which the background color is changed, and, for example, a method in which one of brightness, intensity and color phase of the background is changed, a method in which a pattern, or the like, is added to the background, or the like, may be employed as appropriate.

In contrast, in a case of the autonomous traveling work machine 11 for which the user U does not have operation authority, as illustrated in the lower part of FIG. 7, the work machine image M is so-called grayed out so as to indicate that the autonomous traveling work machine 11 cannot be selected. This allows the user U of the operation device 51 to visually confirm that the user U does not have operation authority for the autonomous traveling work machine 11 while grasping existence of the autonomous traveling work machine 11.

In this case, the work machine image M may be grayed out in such a way that a semitransparent gray layer is superimposed on the work machine image M or that transparency of a layer of the work machine image M is adjusted, or the work machine image M may be grayed out by adjusting intensity, or the like.

The lower part of FIG. 7 illustrates a case where, as the work machine image M of the operable/other status ST1, an image obtained by superimposing a semitransparent gray layer Mos1 on the work machine image M of the same status ST1 in the upper part of FIG. 7 is used, as the work machine image M of the teaching status ST2, an image obtained by superimposing a semitransparent gray layer Mos2 on the work machine image M of the same status ST2 in the upper part is used, as the work machine image M of the playback status ST3, an image obtained by superimposing a semitransparent gray layer Mos3 on the work machine image M of the same status ST3 in the upper part is used, and as the work machine image M of the abnormal status ST4, an image obtained by superimposing a semitransparent gray layer Mos4 on the work machine image M of the same status ST4 in the upper part is used. Note that FIG. 7 illustrates the respective gray layers Mos1 to Mos4 with hatching.

These work machine images M allow the user U of the operation device 51 to grasp and recognize the position of the autonomous traveling work machine 11 and visually confirm whether or not the autonomous traveling work machine 11 is the autonomous traveling work machine 11 for which the user U has operation authority. It is also possible to display that the user U does not have operation authority in other ways than gray-out or hide the autonomous traveling work machine 11 for which the user U does not have operation authority.

Operation of the operation device 51 will be described next with reference to the drawings.

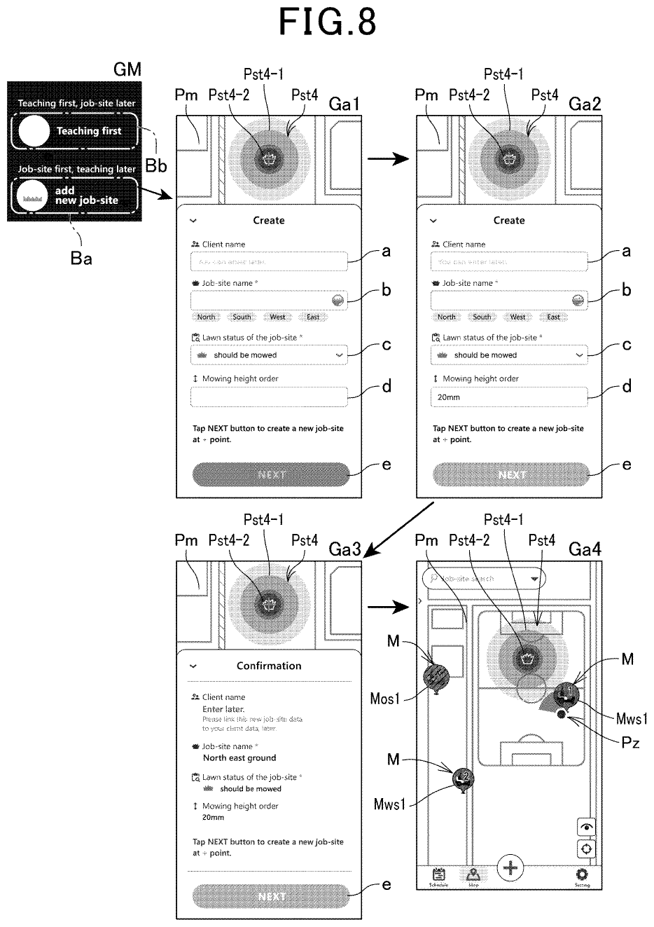

As illustrated in FIG. 8, the operation device 51 displays a menu screen GM in accordance with operation by the user U. The menu screen GM is, for example, displayed in a superimposed manner on the map image Pm.

In the menu screen GM, an operation button Ba (“add new job-site” in FIG. 8) for starting registration of the work area, and an operation button Bb (“Teaching first” in FIG. 8) for starting teaching are displayed.

Note that in the present embodiment, the user U of the operation device 51 can smoothly perform teaching after registration of the work area, that is, perform “job-site first, teaching later (teaching after registration of the work area)” by depressing the operation button Ba. Further, the user U of the operation device 51 can smoothly register the work area after teaching, that is, “teaching first, job-site later (registration of the work area after teaching)” by depressing the operation button Bb.

In a case where the operation button Ba is depressed, a display screen Ga1 illustrated in FIG. 8 is displayed.

The map image Pm in the display screen Ga1 is a map image including the work area to be registered, and, for example, is a map image displayed by the user U moving the map image Pm or inputting an address, or the like, of the work area.

In the display screen Ga1, an input form a of a client name (for example, a client name for a lawn cutting business operator), an input form b of a work area name, an input form c of a condition (lawn condition) of the work area, an input form d of a cutting height, and a next button (NEXT) e are displayed. Note that the next button e is grayed out so as to indicate that depression is invalidated until essential information is input.

If the essential information is input, as illustrated in a display screen Ga2, a display state of the next button e is changed to a state where depression is validated, and if the next button e is depressed, a display screen Ga3 is displayed.

In the display screen Ga3, a confirmation screen for the input content is displayed, that is, information input to the display screen Ga2 is displayed. If the next button e is depressed in the display screen Ga3, a display screen Ga4 is displayed.

In the display screen Ga4, the work machine image M of the registered autonomous traveling work machine 11 is displayed in a superimposed manner on the map image Pm. In this case, by the control unit 51a of the operation device 51 transmitting the input information to the server device 31 by the communication unit 51e, information on the registered work area is registered in the server device 31, more specifically, the work area data is updated. Further, the operation device 51 acquires the information on the autonomous traveling work machine 11, and the like, from the server device 31 by the communication unit 51e, generates the work machine image M of the autonomous traveling work machine 11 located within an area of the map image Pm that is being displayed and displays the work machine image M in a superimposed manner on the map image Pm.

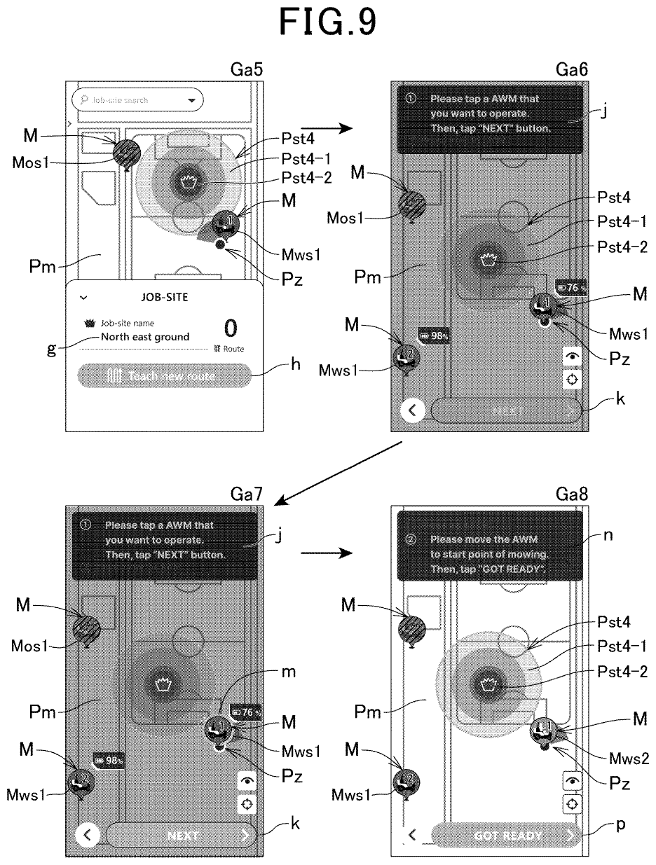

In the display screen Ga4, if the user U performs operation of selecting the work area for which teaching is to be performed, a display screen Ga5 illustrated in FIG. 9 is displayed. In the display screen Ga5, a name g of the selected work area for which teaching is to be performed, an operation button h for giving an instruction to start teaching, and the like, are displayed.

In a case where the operation button h is depressed, a display screen Ga6 illustrated in FIG. 9 is displayed. In the display screen Ga6, the work machine image M of the autonomous traveling work machine 11 located around the selected work area is displayed in a superimposed manner on the map image Pm, and a message j that encourages selection of the autonomous traveling work machine 11 to be used for teaching, a next button k, and the like, are displayed.

In the display screen Ga6 and the respective drawings which will be described later, a battery remaining amount (for example, 76%, 98% in FIG. 9) that is a remaining amount of energy is displayed for the autonomous traveling work machine 11 for which the user U has operation authority. The battery remaining amount is displayed in a superimposed manner on the map image Pm in the vicinity of the work machine image M. Note that the battery remaining amount includes information acquired by the operation device 51 from the server device 31.

In the display screen Ga6, a case is illustrated where identification data (identification image) of the autonomous traveling work machine 11 for which the user U of the operation device 51 has operation authority is “1” and “2”, and identification data (identification image) of the autonomous traveling work machine 11 for which the user U does not have operation authority is “Am”. Further, in the display screen Ga6, the next button k is grayed out so as to indicate that depression is invalidated.

If the work machine image M of the autonomous traveling work machine 11 for which the user U has operation authority is selected in the display screen Ga6, a display screen Ga7 is displayed. In the display screen Ga7, an additional image m indicating a selected state is added to the work machine image M of the selected autonomous traveling work machine 11 (autonomous traveling work machine with the identification data of “1”), and a display state of the next button k is switched from a gray-out state indicating that depression is invalidated to a display state indicating that depression is validated.

Note that even if the user U of the operation device 51 has operation authority for the autonomous traveling work machine 11, if a work such as teaching and playback is allocated to the autonomous traveling work machine 11 which is in an abnormal state or performing another playback or another teaching, it may be difficult to understand handling of the autonomous traveling work system 1, which is not preferable. Thus, in the present embodiment, even if the user U of the operation device 51 has operation authority, the autonomous traveling work machine 11 that is in an abnormal state, performing playback and teaching is configured so as not to be selectable. In other words, the autonomous traveling work machine 11 to which a work such as teaching and playback can be allocated is limited to autonomous traveling work machine (autonomous traveling work machine of the work machine image M with the background color Mws1) for which the user U has operation authority and which corresponds to the operable/other status ST1 illustrated in FIG. 7.

If the next button k is depressed in the display screen Ga7, a display screen Ga8 is displayed. In the display screen Ga8, a message n that encourages depression of a start button (GOT READY) p after the autonomous traveling work machine 11 moves to a start point (which can be said as a work start position or a teaching start position), and a start button p are displayed. Further, in the display screen Ga8, the work machine image M of the selected autonomous traveling work machine 11 is switched to an image indicating during teaching, that is, the work machine image M (work machine image M with the background color Mws2) in the teaching status ST2 illustrated in FIG. 7.

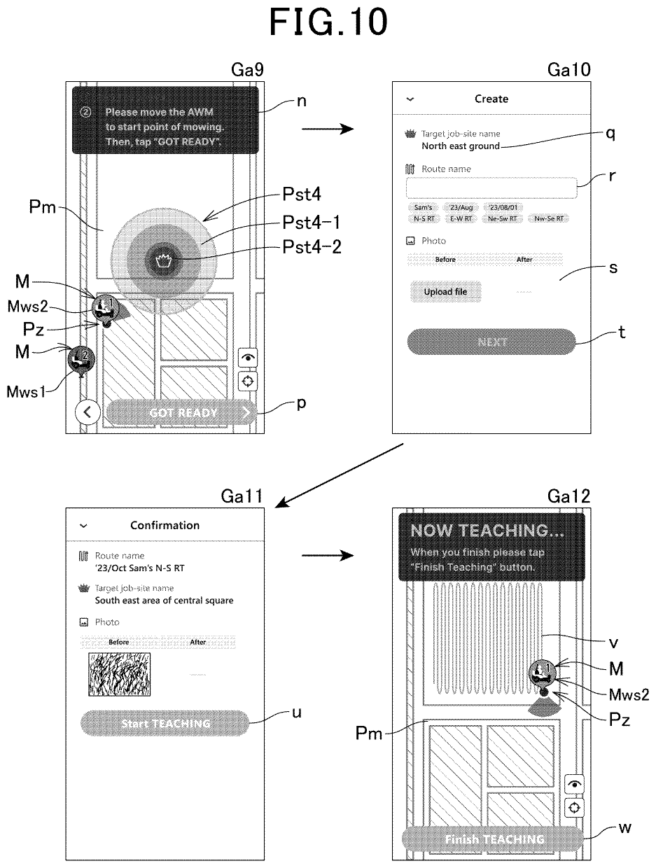

A display screen Ga9 illustrated in FIG. 10 indicates a display screen when the user U manually drives the autonomous traveling work machine 11 (autonomous traveling work machine with the identification data of “1”) to move the autonomous traveling work machine 11 to the start point. If the start button p is depressed in the display screen Ga9, a display screen Ga10 illustrated in FIG. 10 is displayed.

In the display screen Ga10, a work area name q for which teaching is to be performed, an input form r of a traveling route name to be used for teaching, a field s for registering photo data before and after teaching of the work area, and a next button t are displayed.

If essential information is input in the display screen Ga10, a display state of the next button t is switched from a gray-out state indicating that operation is invalidated to a display state indicating that operation is validated, and if the next button t is depressed, a display screen Ga11 is displayed.

In the display screen Ga11, a confirmation screen for the input content is displayed, that is, the information input to the display screen Ga10 is displayed. In the display screen Ga11, an operation button u for giving an instruction to start teaching is also displayed, and if the operation button u is depressed, a display screen Ga12 is displayed.

The display screen Ga12 is a screen indicating a teaching state. In the display screen Ga12, a message indicating that teaching is being performed is displayed, and a traveling route v of the autonomous traveling work machine 11 for which teaching is being performed is displayed in real time in a superimposed manner on the map image Pm.

Note that during teaching, the user U is performing a lawn cutting work while setting the mode of the autonomous traveling work machine 11 to a manual driving mode, and the autonomous traveling work machine 11 transmits position information to the server device 31 and acquires data (traveling work data) so as to be able to reproduce the work by manual driving. The information received by the operation device 51 from the server device 31 includes the position information of the autonomous traveling work machine 11 for which teaching is being performed. Thus, the traveling route of the autonomous traveling work machine 11 for which teaching is being performed can be displayed on the operation device 51 side by utilizing this position information. Further, an operation button w for giving an instruction to end teaching is also displayed in the display screen Ga12.

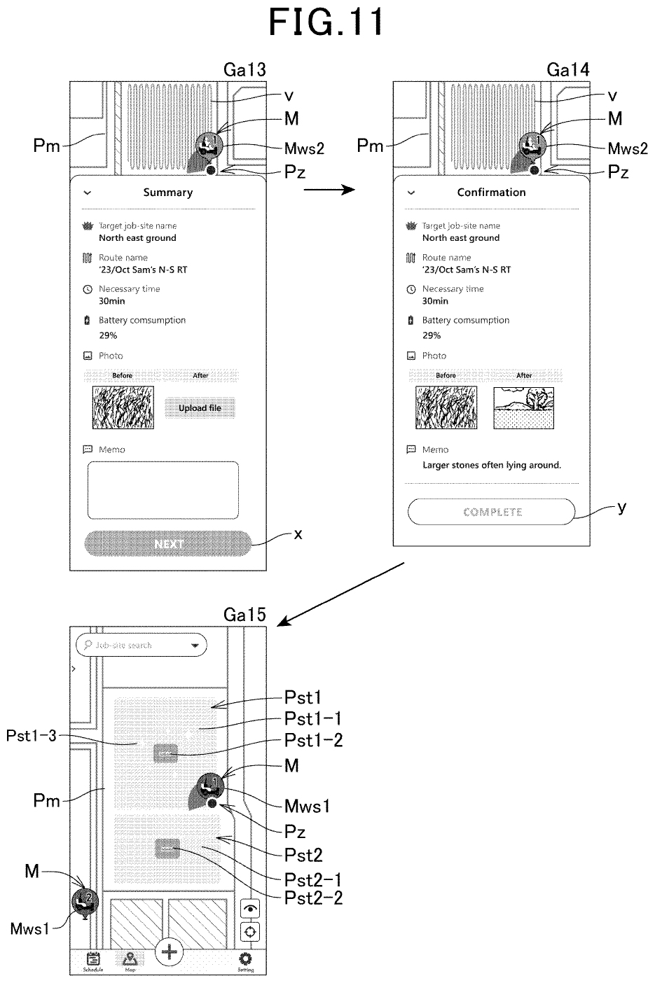

A display screen Ga13 in FIG. 11 is a screen to be displayed after the user U ends manual driving (corresponding to the lawn cutting work for teaching) of the autonomous traveling work machine 11 and depresses the operation button w. In the display screen Ga13, the traveling route v along which the teaching has been performed is displayed in a superimposed manner on the map image Pm, and a work area name for which the teaching has been performed, a traveling route name, a work period, a battery consumption amount, a field for memorandum, a next button x, and the like, are displayed.

The work period and the battery consumption amount are an actual work period and an actual battery consumption amount measured during teaching. Note that the work period and the battery consumption amount are information measured by one of the autonomous traveling work machine 11, the server device 31 and the operation device 51. The field for memorandum is a field in which the user U can input appropriate character information.

If the next button x is depressed, a display screen Ga14 illustrated in FIG. 11 is displayed. The display screen Ga14 is a confirmation screen for the teaching content, and an operation button (COMPLETE) y for completing confirmation is also displayed. If the operation button y is depressed, a display screen Ga15 of the map image Pm illustrated in FIG. 11 is displayed.

In the display screen Ga15, the work area image Pst1 corresponding to the work completion status ST1 is displayed, that is, the area status display element Pst1-2 and the decorative image Pst1-3 indicating that lawn has just been cut is displayed in the work area for which the lawn cutting work has been completed by teaching. Further, for the autonomous traveling work machine 11 with “1” used for teaching, the work machine image M is switched from the work machine image M (work machine image M with the background color Mws2) in the teaching status ST2 to the work machine image M (work machine image M with the background color Mws1) in the operable/other status ST1.

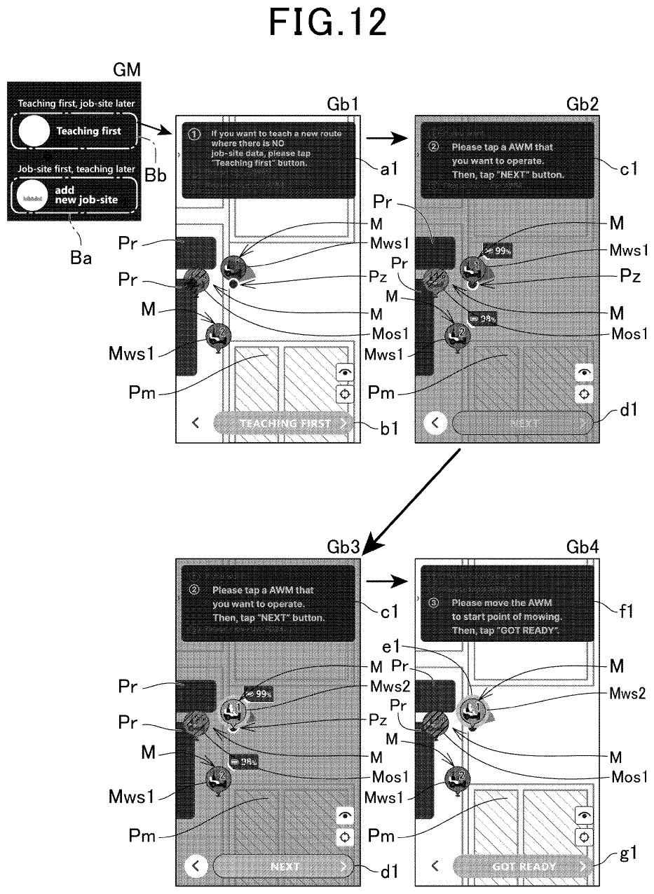

FIG. 12 to FIG. 14 are views illustrating display screens in a case where the operation button Bb in the menu screen GM is depressed, that is, in a case where teaching is started. As described above, by the operation button Bb being depressed, the work area for which teaching has been performed can be smoothly registered after the teaching is performed.

In a case where the operation button Bb is depressed, a display screen Gb1 illustrated in FIG. 12 is displayed. Here, a registered work area portion Pr on the map image Pm is displayed with a semitransparent black layer, or the like. This allows the user U to easily grasp portions for which areas are to be registered by teaching lawn cutting.

In the display screen Gb1, the map image Pm including the work area for which teaching is to be performed is displayed, and the map image Pm is a map image displayed by the user U, for example, moving the map image Pm or inputting an address, or the like, of the work area.

In the display screen Gb1, in a case where teaching of a traveling route is performed on a work area that has not been registered, a message a1 that encourages depression of an operation button b1 is displayed in a superimposed manner on the map image Pm, and the operation button b1 that gives an instruction to start teaching is displayed. Further, in the display screen Ga1, the work machine image M of the autonomous traveling work machine 11 located within an area of the map image Pm that is being displayed.

In a case where the operation button b1 is depressed, a display screen Gb2 illustrated in FIG. 12 is displayed.

In the display screen Gb2, the work machine image M is displayed in a superimposed manner on the map image Pm in a similar manner to the display screen Gb1, and a message cl that encourages selection of the autonomous traveling work machine 11 to be used for teaching, a next button d1, and the like, are displayed.

In the display screen Gb2, a case is illustrated where identification data (identification image) of the autonomous traveling work machine 11 for which the user U of the operation device 51 has operation authority is “1” and “2”, and identification data (identification image) of the autonomous traveling work machine 11 for which the user U does not have operation authority is “Am”. Further, in the display screen Gb2, a battery remaining amount (99%, 98% in FIG. 12) of the autonomous traveling work machine 11 for which the user U has operation authority is displayed, and the next button d1 is grayed out so as to indicate that depression is invalidated.

Note that in the display screen Gb1 and respective screens Gb2 to Gb8 which will be described later, areas already including the work area are displayed with lower transparency.

If the work machine image M (work machine image M with the background color Mws1) of the autonomous traveling work machine 11 for which the user U has operation authority and which is in the operable/other status ST1 is selected in the display screen Gb2, the display screen Gb3 is displayed. In the display screen Gb3, an additional image e1 indicating a selected state is added to the selected work machine image M (work machine image of the autonomous traveling work machine 11 with the identification data of “1”), and a display state of the next button d1 is switched from a gray-out state indicating depression is invalidated to a display state indicating that depression is validated.

Note that in the display screens Gb2 and Gb3, while the map image Pm is grayed out in such a way that a semitransparent gray layer is superimposed on the map image Pm, or the like, the work machine image M is not grayed out. This can make the work machine image M conspicuous.

If the next button d1 is depressed in the display screen Gb3, the display screen Gb4 is displayed. In the display screen Gb4, a message f1 that encourages depression of a start button (GOT READY) g1 after the autonomous traveling work machine 11 corresponding to the selected work machine image M moves to a start point (work start position), and the start button g1 are displayed. In this case, the selected work machine image M is switched to the work machine image M in the teaching status ST2 (work machine image M with the background color Mws2).

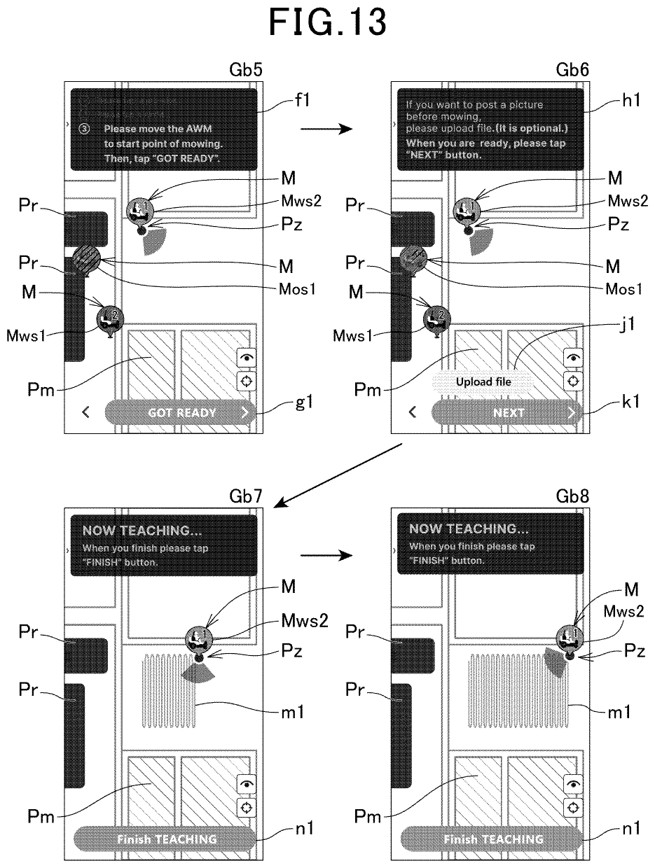

The display screen Gb5 illustrated in FIG. 13 illustrates a display screen when the user U has manually driven the autonomous traveling work machine 11 to move the autonomous traveling work machine 11 to the start point. If the start button g1 is depressed in the display screen Gb5, the display screen Gb6 illustrated in FIG. 13 is displayed.

In the display screen Gb6, a message hl regarding registration of photo data before teaching of the traveling route, an upload button j1 of the photo data, and a next button k1 are displayed. If the next button k1 is depressed in the display screen Gb6, the display screen Gb7 indicating a teaching state is displayed.

In the display screen Gb7, a message indicating during teaching is displayed, and a traveling route ml of the autonomous traveling work machine 11 for which teaching is being performed is displayed in substantially real time in a superimposed manner on the map image Pm. In the display screen Gb7, an operation button n1 that gives an instruction to end teaching is also displayed.

The display screen Gb7 is the same as the display screen Ga12 described above, and processing for displaying the display screen Gb7, that is, processing for displaying the traveling route ml, and the like, of the autonomous traveling work machine 11 for which teaching is being performed is also the same as processing for displaying the display screen Ga12.

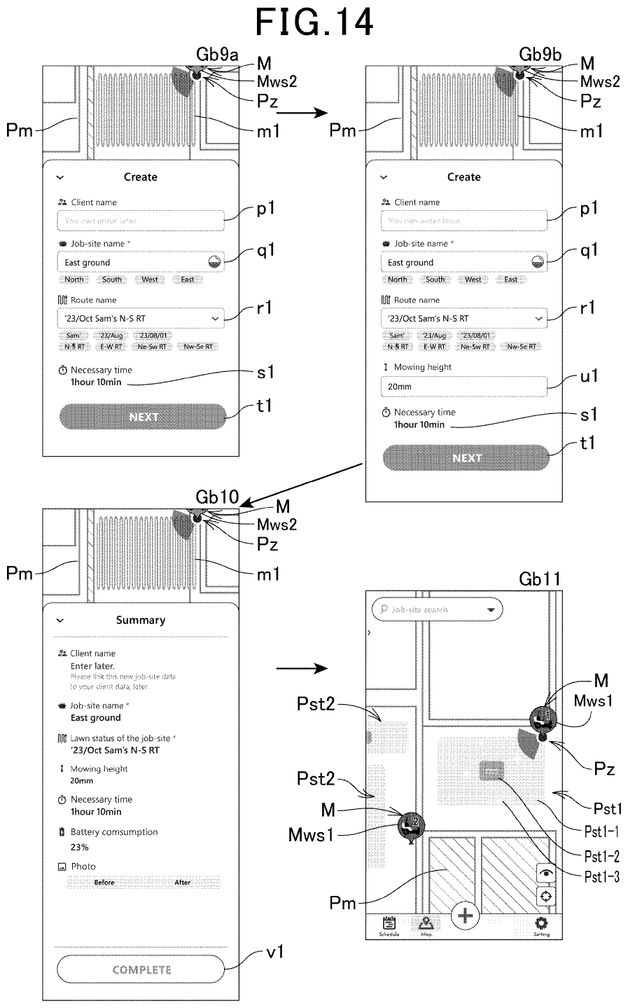

The display screen Gb8 is an image at a time point at which the user U ends manual driving (lawn cutting work for teaching) of the autonomous traveling work machine 11. In a case where the user U depresses the operation button n1, a display screen Gb9a illustrated in FIG. 14 is displayed.

In the display screen Gb9a, the traveling route ml along which the teaching has been performed is displayed in a superimposed manner on the map image Pm, and an input form p1 of a client name (for example, a client name for a lawn cutting business operator), an input field q1 of a work area name, an input field r1 of the traveling route along which the teaching has been performed, a work period s1, and a next button t1 are displayed. Note that in place of the display screen Gb8, a display screen Gb9b in which an input field u1 of a cutting height is added may be displayed.

Further, a battery consumption amount may be displayed in the display screens Gb9a and Gb9b. The work period s1 and the battery consumption amount are an actual work period and an actual battery consumption amount measured during teaching and are information measured by one of the autonomous traveling work machine 11, the server device 31 and the operation device 51.

If the next button t1 is depressed, a display screen Gb10 illustrated in FIG. 14 is displayed. The display screen Gb10 is a confirmation screen for the teaching content, and an operation button v1 for completing confirmation is also displayed. If the operation button v1 is depressed, a display screen Gb11 of the map image Pm illustrated in FIG. 14 is displayed.

In the display screen Gb11, the work area image Pst corresponding to the work completion status ST1, that is, the work area image Pst indicating that lawn has just been cut is displayed in the work area for which the lawn cutting work has been completed by teaching. Further, the work machine image of the autonomous traveling work machine 11 of “1” used for teaching is switched from the work machine image M in a teaching state to the work machine image M in an “operable/other” state.

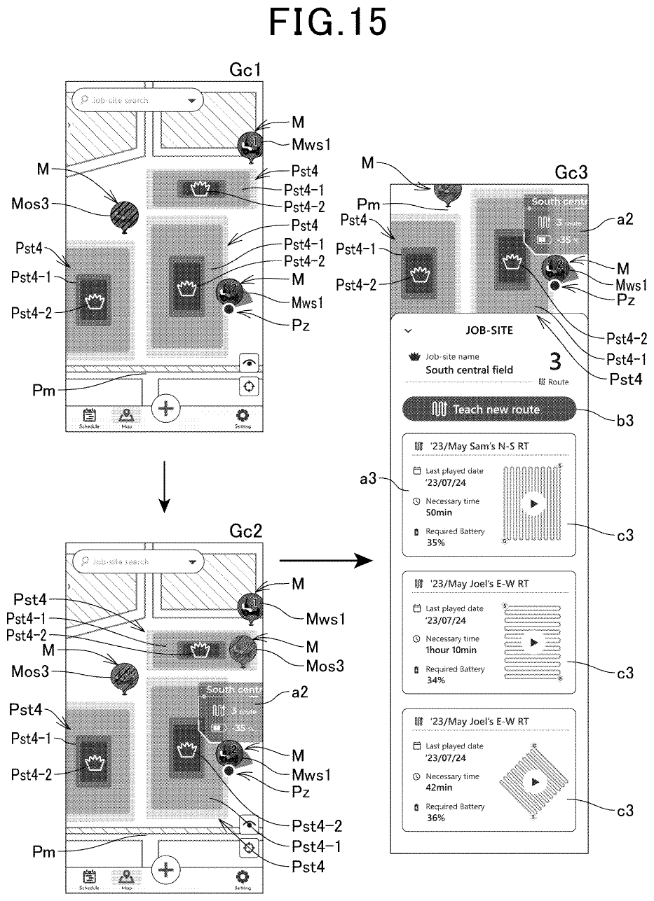

FIG. 15 to FIG. 19 are views illustrating display screens in a case where playback is started. The playback is control of automatically driving the autonomous traveling work machine 11 based on the traveling work data created by teaching to reproduce the work (lawn cutting work) by manual driving.

The map image Pm in the display screen Gc1 illustrated in FIG. 15 is the map image Pm including the work area in which playback is to be performed and is a map image displayed by the user U moving the map image Pm or inputting an address, or the like, of the work area.

As illustrated in a display screen Gc2 in FIG. 15, information a2 regarding the work area is displayed by the user U performing predetermined operation (for example, operation of selecting the work area image Pst corresponding to the work area in which playback is to be performed) in a state where the display screen Gc1 is displayed. The information a2 includes a work area name, the number of pieces of traveling work data (“3 routes” in the figure) that is teaching data in the work area, a battery consumption amount (“−35%” in the figure) required for the lawn cutting work, and the like. Note that the information a2 is information obtained from the data stored in the server device 31.

Further, by the user U performing predetermined operation, a display screen Gc3 that allows confirmation and selection of the traveling work data to be used for playback is displayed.

In the display screen Gc3 illustrated in FIG. 15, a screen a3 indicating traveling routes, and the like, of the respective three pieces of the traveling work data is displayed, and the user U can select one of the traveling routes. More specifically, in the screen a3, a route display image c3 indicating a traveling route name, date of last use (last played date), a work period, a battery consumption amount, a route of the traveling route, and the like, is displayed based on each piece of the traveling work data of the selected work area. The user U can select a traveling route by operation of selecting (for example, operation of depressing) one of the route display images c3. Note that in the display screen Gc3, an operation button b3 for starting newly creating a traveling route is also displayed.

The traveling route corresponds to one example of an “autonomous moving route” of the present invention, and the operation button b3 corresponds to one example of an “addition button that accepts addition of the autonomous moving route” of the present invention. Further, the screen a3 corresponds to one example of a “list of autonomous moving routes, and a selection screen that accepts selection of the autonomous moving route” of the present invention.

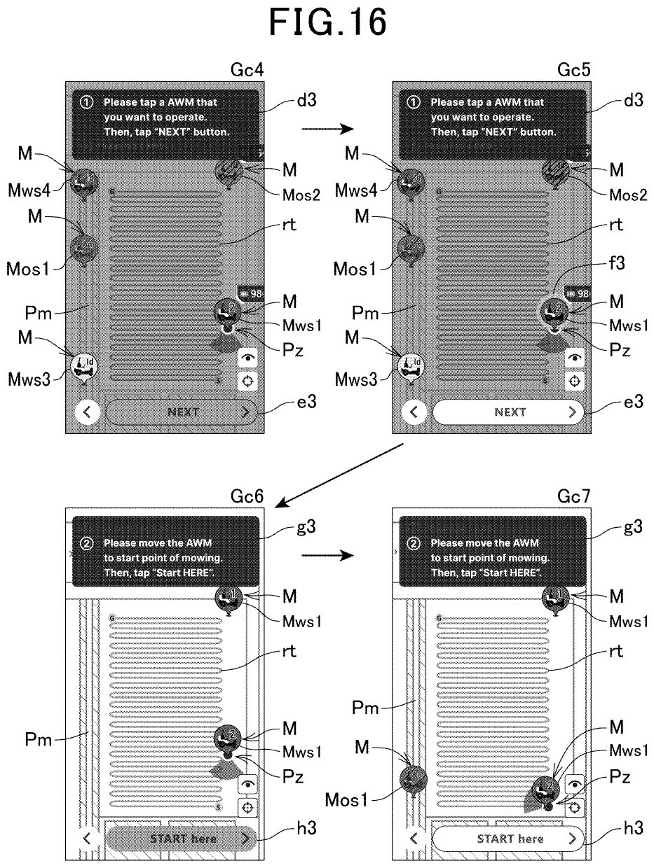

A display screen Gc4 in FIG. 16 is a display screen in a case where traveling work data to be used for playback is selected. In the display screen Gc4, the traveling route c3 of the selected traveling work data, and the work machine image M of the autonomous traveling work machine 11 around the traveling route (corresponding to around the work area in which playback is to be performed) are displayed in a superimposed manner on the map image Pm, and a message d3 that encourages selection of the autonomous traveling work machine 11 to be used for playback, and a next button e3 are displayed.

In the display screen Gc4, a case is illustrated where the autonomous traveling work machine 11 for which the user U of the operation device 51 has operation authority and which is in the operable/other status ST1 (autonomous traveling work machine of the work machine image M with the background color Mws1) is the autonomous traveling work machine 11 with the identification data (identification image) of “2”. Further, a case is illustrated where, in the area of the map image PM in the display screen Gc4, the autonomous traveling work machine 11 (autonomous traveling work machine of the work machine image M with the background color Mws3) for which the user U has operation authority and which is in the playback status ST3, the autonomous traveling work machine 11 (autonomous traveling work machine of the work machine image M with the background color Mws4) for which the user U has operation authority and which is in the abnormal status ST4 including the system error state, and the autonomous traveling work machine 11 (autonomous traveling work machine of the work machine image M with the background color Mws2) for which the user U does not have operation authority and which is in the teaching status ST2 exist.

A battery remaining amount that is a remaining amount of energy is displayed for the autonomous traveling work machine 11 for which the user U has operation authority and which is in the operable/other status ST1, and thus, the user U can select the autonomous traveling work machine 11 that satisfies the battery consumption amount (battery consumption amount of the selected traveling work data) displayed in the immediately preceding display screen Gc3.

Note that in the display screen Gc4, a next button e3 is grayed out so as to indicate that depression is invalidated.

If the work machine image M of the autonomous traveling work machine 11 for which the user U has operation authority and which is in the operable/other status ST1 is selected in the display screen Gc4, a display screen Gc5 is displayed. In the display screen Gc5, an additional image f3 indicating a selected state is added to the selected work machine image M of the autonomous traveling work machine 11 (autonomous traveling work machine 11 with the identification data of “2”), and a display state of the next button e3 is switched from a gray-out state indicating that depression is invalidated to a display state indicating that depression is validated.

If the next button e3 is depressed in the display screen Gc5, a display screen Gc6 is displayed. In the display screen Gc6, a message g3 that encourages depression of a start button (START here) h3 after the autonomous traveling work machine 11 moves to a start point, and the start button h3 are displayed.

Here, the autonomous traveling work machine 11 has not reached the start point at a time point of the display screen Gc6, and thus, the start button h3 is displayed in a gray-out state to indicate that depression is invalidated.

If the user U manually drives the autonomous traveling work machine 11 to move the autonomous traveling work machine 11 within a predetermined distance from the start point (work start position), as illustrated in a display screen Gc7, a display state of the start button h3 is switched from the gray-out state indicating that depression is invalidated to a display state indicating that depression is validated. The predetermined distance may be set at an appropriate distance that can be regarded as the start point, and, for example, set at a distance at which playback can be started. This allows the user U to easily recognize that the autonomous traveling work machine 11 has moved to the start point.

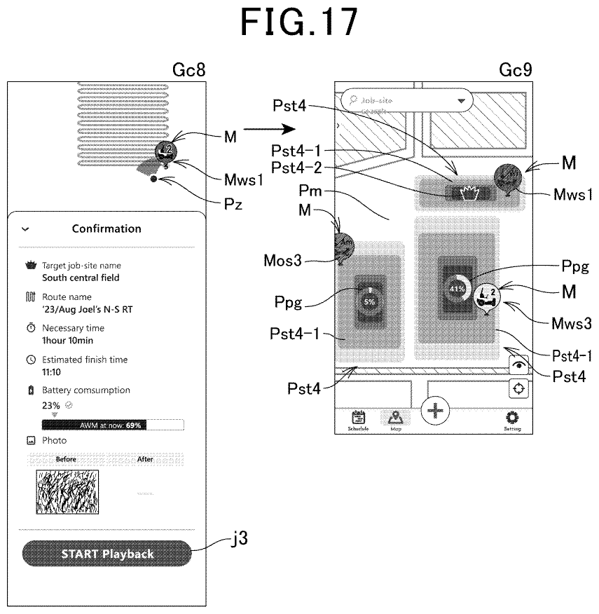

If the user U gets off the autonomous traveling work machine 11 and depresses the start button h3, a display screen Gc8 illustrated in FIG. 17 is displayed.

In the display screen Gc8, a confirmation screen for the input content is displayed, that is, the work area selected by the user U, the traveling work data, information on the autonomous traveling work machine 11, and the like, are displayed. More specifically, a work area name for which playback is to be performed, a traveling route name to be used for playback, a work period, an expected end time point, a battery consumption amount, a battery remaining amount, a field for registering photo data before and after teaching of the work area, and a start button (START Playback) j3 are displayed.

Here, display of the battery consumption amount and the battery remaining amount enables the user U to confirm whether or not the autonomous traveling work machine 11 is the autonomous traveling work machine 11 having energy necessary for the work.

If the start button j3 in the display screen Gc8 is depressed, a signal that gives an instruction to start the work is directly transmitted to the autonomous traveling work machine 11 or transmitted to the autonomous traveling work machine 11 via the server device 31, thereby, the autonomous traveling work machine 11 starts operation of playback. Note that publicly known techniques can be widely applied as a method for starting operation of playback, a method for controlling the autonomous traveling work machine 11 during playback, and the like.

If the autonomous traveling work machine 11 starts operation of playback, a display screen Gc9 indicating a playback state is displayed. In the display screen Gc9, the work machine image M of the autonomous traveling work machine 11 during playback is displayed with the work machine image M (work machine image M with the background color Mws3) in the playback status ST3, and an image Ppg (hereinafter, referred to as a “progress display image Ppg”) indicating progress of the playback is displayed in a superimposed manner on the map image Pm. This allows the user U of the operation device 51 to easily visually confirm that playback is being performed and the progress of the playback.

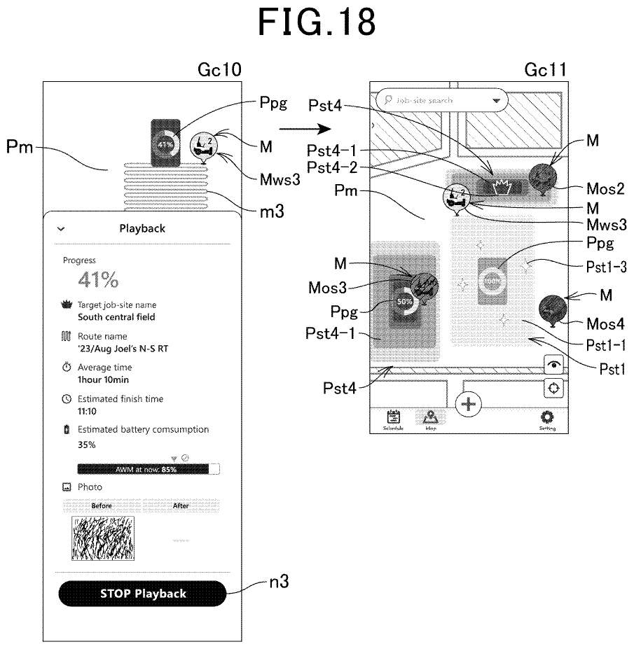

By the user U performing predetermined operation (for example, operation of selecting the work area image Pst corresponding to the work area in which playback is being performed) in the display screen Gc9, a display screen Gc10 illustrated in FIG. 18 is displayed.

In the display screen Gc10, a message indicating that playback is being performed is displayed, and a traveling route m3 of the autonomous traveling work machine 11 that is performing playback and the progress display image Ppg are displayed in real time in a superimposed manner on the map image Pm. Further, in the display screen Gc10, information on a numerical value (“41%” in FIG. 18) indicating the progress of the playback, the work area name, the traveling route name, and the like, is displayed, and an operation button (STOP Playback) n3 that gives an instruction to interrupt the playback is displayed.

In a case where the operation button n3 that gives an instruction to interrupt the playback is depressed, a signal that gives an instruction to interrupt the playback is directly transmitted from the operation device 51 to the autonomous traveling work machine 11 or transmitted to the autonomous traveling work machine 11 via the server device 31, thereby the autonomous traveling work machine 11 interrupts the operation of the playback. Note that in a case where the operation of the playback is interrupted, a fact that the operation of the playback is interrupted is described in the traveling work history data of the server device 31.

On the other hand, in a case where the operation button n3 that gives an instruction to interrupt the playback is not depressed, if the autonomous traveling work machine 11 continues the operation of the playback and completes the lawn cutting work, information on a work completion timing is transmitted from the autonomous traveling work machine 11 to the server device 31, the operation device 51, and the like.

A display screen Gc11 illustrated in FIG. 18 is a display example at a time point at which the progress of the playback has reached 100%, that is, the lawn cutting work has been completed. In the display screen Gc11, the progress display image Ppg indicating the progress (“100%” in FIG. 18) of the playback is displayed, and the work area image Pst1 (including the area status display element Pst1-2 and the decorative image Pst3) corresponding to the work completion status ST1 is displayed.

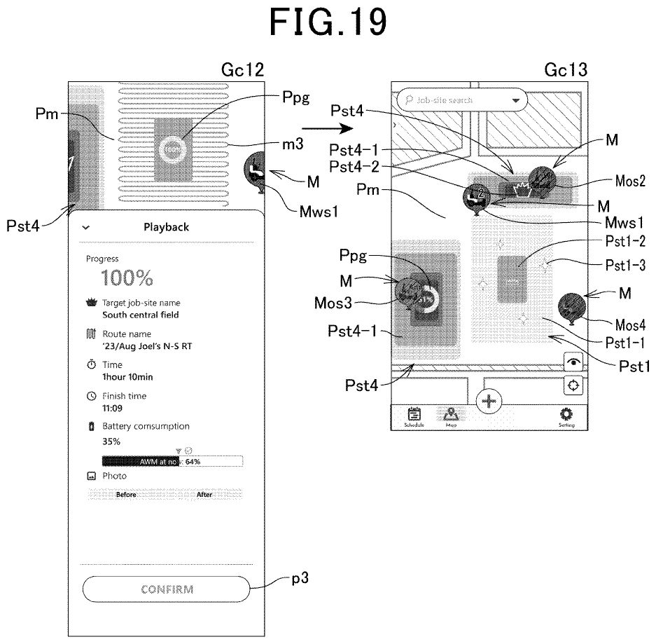

By the user U performing predetermined operation (for example, operation of selecting the work area image Pst1 corresponding to the work area for which the progress of the playback is 100%) in the display screen Gc11, a display screen Gc12 illustrated in FIG. 19 is displayed. The display screen Gc12 is a screen indicating a playback result, and an operation button (CONFIRM) p3 for completing confirmation is also displayed. If the operation button p3 is depressed, a display screen Gc13 of the map image Pm illustrated in FIG. 19 is displayed.

In the display screen Gc13, the work area image Pst1 corresponding to the work completion status ST1 is displayed in the work area for which the lawn cutting work has been completed by the playback is displayed, that is, a work area image indicating that lawn has just been cut is displayed. Further, the work machine image of the autonomous traveling work machine 11 with “2” used for the playback is switched from the work machine image M in the playback status ST3 to the work machine image M in the operable/other status ST1.

As described above, the operation device 51 of the present embodiment includes the control unit 51a that functions as a display terminal control unit that displays the map image Pm at the display unit 51c by executing the map application and acquires information regarding one or more work areas. The control unit 51a displays the work area image Pst indicating a position of the work area and a status of the work area in a superimposed manner on the map image Pm as illustrated in FIG. 5, and the like, based on the acquired information.

As illustrated in FIG. 3, the status of the work area includes the work completion status ST1 corresponding to a condition during a predetermined period from a work completion timing at which a lawn cutting work that is a predetermined work for the work area has been completed, and a work required status ST4 corresponding to a condition that requires a lawn cutting work after the predetermined period has elapsed.

Note that in the example, the status of the work area is managed so as to be automatically updated by the interface unit 31b of the server device 31 to the work completion status ST1, the first transition status ST2, the second transition status ST3 and the work required status ST4.

According to this configuration, as illustrated in FIG. 5, FIG. 6, and the like, it is possible to provide the operation device 51 that displays a location and a condition of a work area in which a work is to be performed in an easily understandable manner by the work area image Pst displayed in a superimposed manner on the map image Pm. This eliminates the necessity of time and effort for the user U to input that the work area becomes a condition that requires a work, so that it is possible to improve user-friendliness of the user U.

Further, as illustrated in FIG. 1, the autonomous traveling work system 1 of the present embodiment includes the server device 31 and the operation device 51. The server device 31 includes the interface unit 31b that functions as a status management unit that determines a work completion timing at which the lawn cutting work has been completed for each of one or more work areas, sets a status of the work area to the work area completion status ST1 corresponding to a condition during a predetermined period from the latest work completion timing and changes the status to the work required status ST4 corresponding to a condition that requires a lawn cutting work after the predetermined period has elapsed. Further, the operation device 51 includes the control unit 51a that functions as the display terminal control unit that displays the map image Pm on the display unit 51c by executing the map application and acquires information regarding one or more work areas.

According to this configuration, it is possible to provide the autonomous traveling work system 1 that displays a location and a condition of a work area in which a work is to be performed in an easily understandable manner by the work area image Pst displayed in a superimposed manner on the map image Pm.

Further, the interface unit 31b that functions as the status management unit sets the status to a transition status (corresponding to the first transition status ST2, the second transition status ST3) corresponding to a status in the middle of changing to the work required status ST4 within a predetermined period after the work completion timing and before the status changes to the work required status ST4 as illustrated in FIG. 3. As illustrated in FIG. 6, the work area image Pst indicating the transition status is an image indicating a state regarding the lawn cutting work for the work area during a period corresponding to each of the first transition status ST2 and the second transition status ST3 that are transition statuses.

According to this configuration, it is possible to make it easier to visually confirm the work area before the work is required by the work area image Pst indicating the transition status and make it easier to achieve efficiency of a work plan and work management of each work area.

As illustrated in FIG. 6, the work area image Pst includes the work area contour image indicating a contour of the work area, the work area contour image is an image with transparency different in accordance with the status of the work area, and is set to an image in which transparency in the work required status ST4 is lower than transparency in the work completion status ST1.

According to this configuration, a difference in the status of the work area can be indicated by a difference in transparency, and the transparency is set lower in the work required status ST4, which makes it easier to visually confirm that the work is required in the work area.

Further, as illustrated in FIG. 6, the figure S having a predetermined shape is provided within the work area image Pst, transparency of at least inside or outside of the figure S is changed in accordance with the status of the work area, and a size of the figure S is increased or decreased in accordance with the status of the work area.

According to this configuration, it is possible to make it easier to visually confirm the work area in which a work is required by lowering transparency of inside of the figure S while preventing decrease in the map information by maintaining transparency of outside of the figure S to a degree at which the map image can be visually confirmed. Further, for example, it is possible to make it easier to conspicuously display whether or not the work area is the work area in which a work is required by increasing and decreasing a size of the image.

Note that it is also possible to employ only one of a method in which the transparency of at least one of inside or outside of the figure S is changed in accordance with the status of the work area and a method in which the size of the figure S is increased or decreased in accordance with the status of the work area.

Further, as illustrated in FIG. 6, in a case of the work completion status ST1, the work area image Pst includes the decorative image Pst1-3 that emphasizes that the status is the work completion status ST1.

According to this configuration, it is possible to emphasize that the status is the work completion status ST1.

As illustrated in FIG. 6, the work area image Pst includes the area status display element Pst2 indicating the status of the work area. The area status display element Pst2 is an image indicating that there is a lot of lawn grass for which the work is to be performed in a case of the work required status ST4 and is an image indicating that there is a few lawn grass for which the work is to be performed in a case of the work completion status ST1. According to this configuration, it is possible to conspicuously display the work area in which the work is required and make it easier to visually confirm the work area in which the work is required by the area status display element Pst2.

Note that a target for which an amount is to be expressed with an image may be made different depending on types of the autonomous traveling work machine 11.

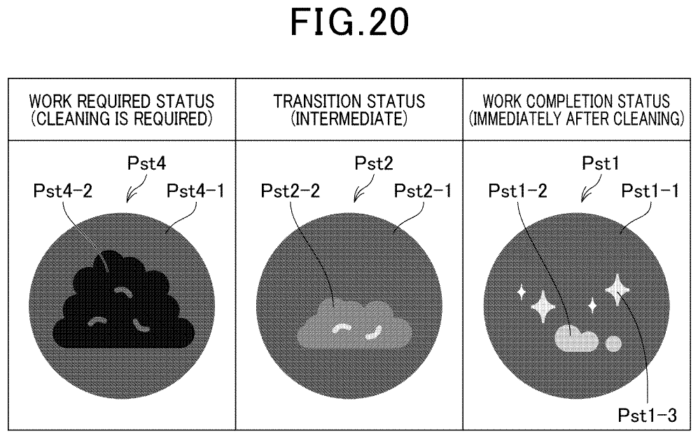

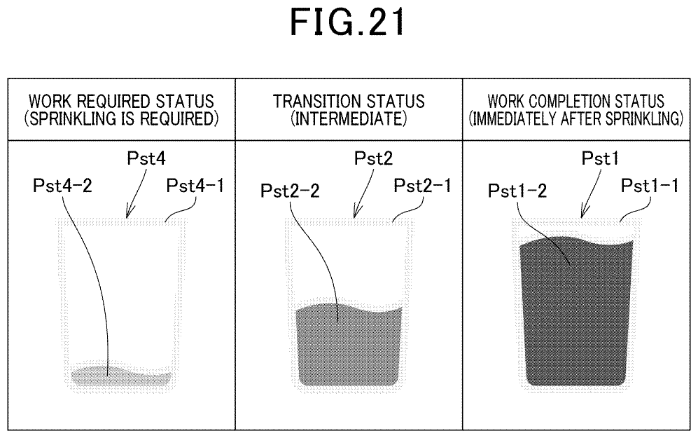

FIG. 20 and FIG. 21 are views illustrating another examples of the work area image Pst.

The work area image Pst illustrated in FIG. 20 is one example of a case where the autonomous traveling work machine 11 is a cleaning truck that performs a cleaning work. The work area image Pst is displayed in a superimposed manner on the map image Pm, and whether or not a cleaning work is required can be indicated by indicating a position of a cleaning area with the area display element Pst1 and indicating a degree of an amount of garbage with the area status display element Pst2. Further, it is possible to emphasize that cleaning has just been performed by the decorative image Pst3.

The work area image Pst illustrated in FIG. 21 is one example of a case where the autonomous traveling work machine 11 is a sprinkler truck that performs a sprinkling work. The work area image Pst is displayed in a superimposed manner on the map image Pm, and whether or not a sprinkling work is required can be indicated by indicating a position of a sprinkling area with the area display element Pst1 and indicating a degree of dryness with the area status display element Pst2.

According to the area status display element Pst2 illustrated in FIG. 20 and FIG. 21, it is possible to conspicuously display the work area in which the work is required and make it easier to visually confirm the work area in which the work is required.

The work area is an area in which the autonomous traveling work machine 11 performs work, and by the autonomous traveling work machine 11 transmitting a work completion timing at which the work for the work area has been completed to the server device 31, the interface unit 31b, and the like, that function as the status management unit of the server device 31 determine the work completion timing of the work area.

According to this configuration, the autonomous traveling work machine 11 coordinates with the interface unit 31b, so that it is possible to reduce time and effort for the user U to perform an input work for managing the work.

Further, as described above, the respective periods T1 to T3 with which the status of the work area is changed are preferably set to appropriate periods. In this case, a period setting table that associates at least one of a region of the work area, a season, a requirement for each region, or individual factors for each region with the respective periods T1 to T3 with which the status of the work area is changed is provided, and the interface unit 31b can easily perform status management corresponding to at least one of the region of the work area, the season, the requirement for each region or the individual factors for each region by determining the respective periods T1 to T3 for each work area based on the period setting table.

Further, the operation device 51 of the present embodiment includes the control unit 51a that functions as the display terminal control unit that acquires each piece of information regarding one or more the autonomous traveling work machines 11 and one or more work areas by executing the map application, displays the map image Pm on the display unit 51c, accepts operation of the user U and instructs the autonomous traveling work machine 11 to perform the work. The control unit 51a displays the work area image Pst indicating the position of the work area and the work machine image M indicating the position of the autonomous traveling work machine 11 in a superimposed manner on the map image Pm based on the acquired information, accepts selection operation of the work area image Pst and the work machine image M and instructs the autonomous traveling work machine 11 corresponding to the selected work machine image M to perform the work in the work area corresponding to the selected work area image Pst.

The information acquired by the control unit 51a includes information with which it is possible to identify whether or not the work can be allocated to the autonomous traveling work machine 11 (such as the status of the autonomous traveling work machine 11 and whether or not the user has operation authority), and the work machine image M is displayed so as to make it possible to discern whether or not the work can be allocated based on the information.

According to this configuration, as illustrated in FIG. 5, FIG. 7, and the like, it is possible to provide the operation device 51 that displays where is the work area in which a work is to be performed and where is the autonomous traveling work machine 11 to which a work can be allocated in an easily understandable manner by the work area image Pst and the work machine image M displayed in a superimposed manner on the map image Pm. Thus, even in a case where a plurality of the autonomous traveling work machines 11 are scattered, the autonomous traveling work machine 11 can be easily selected. Further, it is not necessary to mount a signal device for identifying whether or not the autonomous traveling work machine 11 is the autonomous traveling work machine 11 to which a work can be allocated, on the autonomous traveling work machine 11, so that it is advantageous to cost reduction.

Further, the autonomous traveling work system 1 of the present embodiment includes the operation device 51 to be operated by the user U, and the autonomous traveling work machine 11 that is one or more autonomous traveling work machines that perform a predetermined work in the work area based on an instruction from the operation device 51. The operation device 51 includes the control unit 51a that functions as the display terminal control unit that acquires information regarding the respective the autonomous traveling work machines 11 and the respective work areas by executing the map application, displays the map image Pm at the display unit 51c, accepts operation of the user U and instructs the autonomous traveling work machine 11 to perform the work. The control unit 51a displays the work area image Pst indicating the position of the work area and the work machine image M indicating the position of the autonomous traveling work machine 11 in a superimposed manner on the map image Pm based on the acquired information, accepts selection operation of the work area image Pst and the work machine image M and instructs the autonomous traveling work machine 11 corresponding to the selected work machine image M to perform a work in the work area corresponding to the selected work area image Pst.

The information received by the operation device 51 includes predetermined information with which it is possible to determine whether or not a work can be allocated to the autonomous traveling work machine 11, and the work machine image M is displayed so as to make it possible to discern whether or not the work can be allocated as illustrated in the display screen Gc4, and the like, in FIG. 7 and FIG. 16.

According to this configuration, it is possible to provide the autonomous traveling work system 1 that displays where is the work area in which a work is to be performed and where is the autonomous traveling work machine 11 to which a work can be allocated in an easily understandable manner by the work area image Pst and the work machine image M displayed in a superimposed manner on the map image Pm.

Further, the above-described predetermined information includes information indicating whether or not the autonomous traveling work machine 11 is in an abnormal state including a system error state, and one of states where a work cannot be allocated to the autonomous traveling work machine 11 is the abnormal state including the system error state. By this means, the work machine image M is displayed so as to make it possible to discern whether or not the autonomous traveling work machine 11 is in an abnormal state including a system error state as illustrated in the display screen Gc4, and the like, in FIG. 7 and FIG. 16. It is therefore possible to avoid a situation where the user U selects the autonomous traveling work machine 11 that cannot be utilized due to a system error state, or the like, that is difficult to be determined from appearance. Further, a signal device for identifying a system error, and the like, is not required on the autonomous traveling work machine 11 side, which is advantageous to cost reduction.

Note that in the above-described embodiment, the work machine image M may be displayed so as to make it possible to discern whether or not the autonomous traveling work machine 11 is in a low energy state. The low energy state is a state where an energy state of an energy source of the autonomous traveling work machine 11 is lower than a predetermined value, and in other words, is a state where a remaining amount of energy can be determined as not sufficient to perform teaching or playback.

In this case, it is only necessary that the above-described predetermined information includes information indicating whether or not the autonomous traveling work machine 11 is in a low energy state, and states where a work cannot be allocated to the autonomous traveling work machine 11 include the low energy state.

This can avoid a situation where the user U performs teaching, playback, or the like, while selecting the autonomous traveling work machine 11 in a low energy state that is difficult to be determined from appearance.

Further, the above-described predetermined information includes information indicating whether or not the autonomous traveling work machine 11 is the autonomous traveling work machine 11 for which the user U has operation authority, and one of states where a work cannot be allocated to the autonomous traveling work machine 11 is a state where the user U does not have operation authority. This enables the user U to easily select the autonomous traveling work machine 11 for which the user U has operation authority.

Further, as illustrated in the display screens Gc6 and Gc7 in FIG. 16, the control unit 51a displays the start button h3 that functions as a work possible identification element indicating that the work can be started when the autonomous traveling work machine 11 moves within a predetermined distance from the start point (work start position) of the work area. This enables the user U to easily visually confirm that the autonomous traveling work machine 11 moves to the start point and can start the work.

Further, the above-described predetermined information includes information indicating whether or not the autonomous traveling work machine 11 is performing playback that is an autonomous traveling work, and one of states where a work cannot be allocated to the autonomous traveling work machine 11 is a state where the autonomous traveling work machine is performing playback. This enables the user U to easily select the autonomous traveling work machine 11 that is not performing playback.

Further, the above-described predetermined information includes information with which it is possible to determine an energy amount necessary for the work and a remaining amount of energy of the autonomous traveling work machine 11, and as illustrated in the display screens Gc2 and Gc3 in FIG. 15, the display screen Gc8 in FIG. 17, the display screen Ga, and the like, in FIG. 9, the control unit 51a that functions as the display terminal control unit can display the energy amount necessary for the work and the remaining amount of energy of the autonomous traveling work machine 11 at the display unit 51c. This enables the user U to confirm whether the autonomous traveling work machine 11 has energy necessary for the work and easily select appropriate autonomous traveling work machine 11.

Further, as illustrated in FIG. 15, the control unit 51a displays the screen a3 used as both a list of traveling routes (autonomous moving routes) available in a case where the autonomous traveling work machine 11 autonomously moves to the work area corresponding to the selected work area image (Pst) and performs a work, and a selection screen that accepts selection of a traveling route, in a superimposed manner on the map image Pm based on operation of the user U.

According to this configuration, the user U can easily recognize and easily select a traveling route available in a case where the autonomous traveling work machine 11 autonomously moves to the work area and performs a work.

Note that a display aspect of the list of the traveling routes and the selection screen may be changed as appropriate, and, for example, the display aspect is not limited to an aspect in which the screen a3 used as both the list of the traveling routes and the selection screen is displayed, and the list of the traveling routes and the selection screen may be separately displayed.

Further, as illustrated in FIG. 15, the control unit 51a displays the operation button b3 that functions as an addition button that accepts addition of a traveling route in a case where the screen a3 is displayed, so that the user U can proceed with operation of adding a traveling route while grasping available traveling routes.

Further, the control unit 51a may have a function of performing processing of accepting selection of a plurality of traveling routes from the user U via the list of the traveling routes and the selection screen and processing of giving an instruction to perform a work in the work area using the accepted plurality of traveling routes.

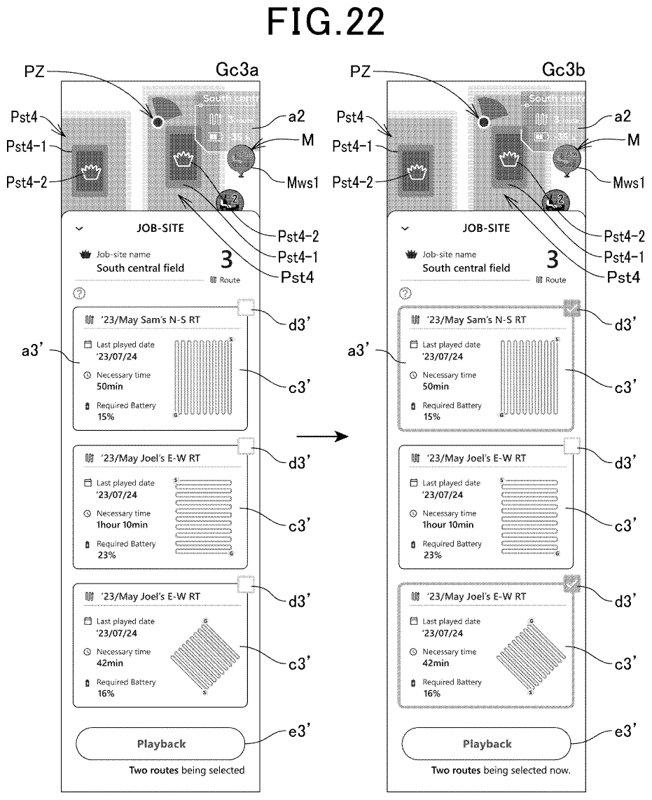

A screen example in this case is illustrated in FIG. 22.

Display screens Gc3a and Gc3b in FIG. 22 correspond to a modification of the display screen Gc3 illustrated in FIG. 15. The display screen Gc3a is, for example, displayed in a superimposed manner on the map image Pm by the user U performing operation of selecting the work area image Pst corresponding to the work area in which playback is to be performed on the image displayed by executing the map application. As illustrated in FIG. 22, a route display image c3′ indicating a traveling route name, date of last use (last played date), a work period, a battery consumption amount, a route of a traveling route, and the like, is displayed in the display screen Gc3a based on each piece of the traveling work data of the selected work area.

Selection of one or more traveling routes can be accepted from the user U in the display screen Gc3a. In the example illustrated in FIG. 22, a checkbox d3′ is displayed in the route display image c3′, and one or more traveling routes can be selected by the user U performing operation of depressing the checkbox d3′.

The display screen Gc3b in FIG. 22 illustrates a case where the user U checks a plurality of (two) checkboxes d3′. Note that an operation button e3′ that gives an instruction to start playback is also displayed in the display screens Gc3a and Gc3b. In a case where the user U performs operation of depressing the operation button e3′, processing of starting playback along the traveling route selected by the user U is executed.

As illustrated in the display screen Gc3b, in a case where a plurality of checkboxes d3′ are checked, playback control is performed so that a lawn cutting work is automatically performed continuously along a plurality of traveling routes corresponding to the plurality of checkboxes d3′.

This can reduce the number of times that the user U gives a work instruction in a case where a lawn cutting work is performed in the same work area using a plurality of traveling routes, so that work efficiency is improved. Further, by using different traveling routes, it is possible to provide a pattern after the work in a case where the lawn cutting work is performed.

### Other Embodiments

The above-described embodiment indicates merely one aspect of the present invention, and modification and application can be arbitrarily made within a range not deviating from the gist of the present invention.

For example, while a case has been described where the present invention is applied to the autonomous traveling work system 1, the operation device 51, the autonomous traveling work machine 11, and the server device 31 illustrated in FIG. 1, and the like, and a control method thereof, the present invention does not have to be limited to the aspect. For example, a configuration of each unit of the autonomous traveling work system 1 may be changed as appropriate. Further, display content and display layout of the operation device 51 may be changed as appropriate, and the work area image Pst and the work machine image M may be also changed as appropriate.

Further, while a case has been described where the present invention is applied to the autonomous traveling work system 1 utilizing the autonomous traveling work machine 11 that performs a lawn cutting work, the operation device 51, and the like, the present invention may be applied to the autonomous traveling work system 1 utilizing the autonomous traveling work machine 11 that performs a predetermined work not limited to a lawn cutting work, the operation device 51, and the like. Examples of the work other than the lawn cutting work can include rice planting, harvesting of rice, cultivation, seeding and harvesting in a field, pruning, cutting and mowing in addition to cleaning, sprinkling and snow removal described above.

### [Configuration to be Supported by the Above-Described Embodiment]

The above-described embodiment supports the following configurations.

(Configuration 1) An information processor including a display terminal control unit that displays a map image on a display unit and acquires information regarding one or more work areas, in which the display terminal control unit displays a work area image indicating a position of the work area and a status of the work area in a superimposed manner on the map image based on the acquired information, and the status includes a work completion status corresponding to a condition during a predetermined period from a work completion timing at which a predetermined work for the work area has been completed, and a work required status corresponding to a condition that requires the work after the predetermined period has elapsed.

According to this configuration, it is possible to provide the information processor that displays a location and a condition of the work area in which a work is to be performed in an easily understandable manner by the work area image displayed in a superimposed manner on the map image.

(Configuration 2) An information processing system including a status management unit that determines a work completion timing at which a predetermined work has been completed for each of one or more work areas, sets a status of the work area to a work completion status corresponding to a condition during a predetermined period from the latest work completion timing and changes the status to a work required status corresponding to a condition that requires the work after the predetermined period has elapsed, and a display terminal control unit that displays a map image on a display unit and acquires information regarding the one or more work areas, in which the display terminal control unit displays a work area image indicating a position of the work area and the status of the work area in a superimposed manner on the map image based on the acquired information.

According to this configuration, it is possible to provide the information processing system that displays a location and a condition of the work area in which a work is to be performed in an easily understandable manner by the work area image displayed in a superimposed manner on the map image.

(Configuration 3) An information processing system according to configuration 2, in which the status management unit sets the status of the work area within a predetermined period after the work completion timing and before the status changes to the work required status, to a transition status corresponding to a status in the middle of changing to the work required status, and the work area image indicating the transition status is an image indicating a state regarding the predetermined work for the work area during a period corresponding to the transition status.

According to this configuration, it is possible to make it easier to visually confirm the work area before the work is required by the work area image indicating the transition status and make it easier to achieve efficiency of a work plan and work management of each work area.

(Configuration 4) The information processing system according to configuration 2 or 3, in which the work area image includes a work area contour image indicating a contour of the work area, and the work area contour image is an image with transparency different in accordance with the status of the work area, and is set to an image in which transparency in the work required status is lower than transparency in the work completion status.

According to this configuration, a difference in the status of the work area can be indicated by a difference in transparency, and the transparency is made lower in the work required status, so that it is possible to make it easier to visually confirm that the work area is in a state where a work is required.

(Configuration 5) The information processing system according to any one of configuration 2 to configuration 4, in which the work area image includes a figure having a predetermined shape, and transparency of at least one of inside or outside of the figure is changed in accordance with the status of the work area, and/or a size of the figure is increased or decreased in accordance with the status of the work area.

According to this configuration, for example, it is possible to make it easier to visually confirm the work area in which a work is required by lowering the transparency of inside of the figure while preventing decrease in map information by maintaining the transparency of outside of the figure to be high enough so that the map image can be visually confirmed. Further, by increasing and decreasing the size of the image, for example, it is possible to make it easier to conspicuously display whether or not the work area is a work area in which a work is required.

(Configuration 6) The information processing system according to any one of configuration 2 to configuration 5, in which in a case of the work completion status, the work area image includes a decorative image that emphasizes that the status is the work completion status.

According to this configuration, it is possible to emphasize that the status is the work completion status ST1.

(Configuration 7) The information processing system according to any one of configuration 2 to configuration 6, in which the work area image includes an area status display element indicating the status of the work area, and the area status display element is an image indicating that there are a lot of targets for which a work is to be performed in a case of the work required status and indicating that there are a few targets for which a work is to be performed in a case of the work completion status.

According to this configuration, it is possible to conspicuously display the work area in which a work is required on the map image by the area status display element and make it easier to visually confirm the work area in which a work is required.

(Configuration 8) The information processing system according to any one of configuration 2 to configuration 7, in which the work area is an area in which autonomous traveling work machine performs a work, and the status management unit determines a work completion timing at which the work for the work area has been completed by the autonomous traveling work machine transmitting information with which the work completion timing in the work area can be identified to the status management unit.

According to this configuration, the autonomous traveling work machine coordinates with the status management unit, so that it is possible to reduce time and effort for a user to perform an input work for managing the work.

(Configuration 9) The information processing system according to any one of configuration 2 to configuration 8, in which a period setting table that associates at least one of a region of the work area, a season, a requirement for each region or individual factors for each region with the predetermined period with which the status of the work area is changed is provided, and the status management unit determines the predetermined period for each work area based on the period setting table.

According to this configuration, it is possible to easily perform status management corresponding to at least one of the region of the work area, the season, the requirement for each region or the individual factors for each region.

(Configuration 10) A control method of an information processor including a display terminal control unit that displays a map image on a display unit and acquires information regarding one or more work areas, in which the display terminal control unit displays a work area image indicating a position of the work area and a status of the work area in a superimposed manner on the map image based on the acquired information, and the status includes a work completion status corresponding to a condition during a predetermined period from a work completion timing at which a predetermined work for the work area has been completed and a work required status corresponding to a condition that requires the work after the predetermined period has elapsed.

According to this configuration, it is possible to provide the control method of the operation device that displays a location and a condition of the work area in which a work is to be performed in an easily understandable manner by the work area image displayed in a superimposed manner on the map image.

### REFERENCE SIGNS LIST

1 information processing system
11 autonomous traveling work machine
31b interface unit (status management unit)
51a control unit (display terminal control unit)
51c display unit
Pst work area image
Pst1 area display element
Pst2 area status display element
M work machine image
M1 autonomous traveling work machine display element
M1a position image
M1b appearance image
M1c machine identification image
M2 autonomous traveling work machine status display element (background color)
S figure (predetermined figure)
ST1 work completion status
ST2 first transition status
ST3 second transition status
ST4 work status
h3 start button (work possible identification element)

What is claimed is:

1. An information processor comprising:
a display terminal control unit that displays a map image on a display unit and acquires information regarding one or more work areas, wherein
the display terminal control unit displays a work area image indicating a position of the work area and a status of the work area in a superimposed manner on the map image based on the acquired information, and
the status includes a work completion status corresponding to a condition during a predetermined period from a work completion timing at which a predetermined work for the work area has been completed, and a work required status corresponding to a condition that requires the work after the predetermined period has elapsed.

2. An information processing system comprising:
a status management unit that determines a work completion timing at which a predetermined work has been completed for each of one or more work areas, sets a status of the work area to a work completion status corresponding to a condition during a predetermined period from the latest work completion timing and changes the status to a work required status corresponding to a condition that requires the work after the predetermined period has elapsed; and
a display terminal control unit that displays a map image on a display unit and acquires information regarding the one or more work areas,
wherein the display terminal control unit displays a work area image indicating a position of the work area and the status of the work area in a superimposed manner on the map image based on the acquired information.

3. The information processing system according to claim 2, wherein
the status management unit sets the status of the work area within a predetermined period after the work completion timing and before the status changes to the work required status, to a transition status corresponding to a status in the middle of changing to the work required status, and
the work area image indicating the transition status is an image indicating a state regarding the predetermined work for the work area during a period corresponding to the transition status.

4. The information processing system according to claim 3, wherein
the work area image includes a work area contour image indicating a contour of the work area, and
the work area contour image is an image with transparency different in accordance with the status of the work area, and is set to an image in which transparency in the work required status is lower than transparency in the work completion status.

5. The information processing system according to claim 3, wherein
the work area image includes a figure having a predetermined shape, and
transparency of at least one of inside or outside of the figure is changed in accordance with the status of the work area, and/or a size of the figure is increased or decreased in accordance with the status of the work area.

6. The information processing system according to claim 3,
wherein in a case of the work completion status, the work area image includes a decorative image that emphasizes that the status is the work completion status.

7. The information processing system according to claim 4, wherein
the work area image includes an area status display element indicating the status of the work area, and
the area status display element is an image indicating that there are a lot of targets for which a work is to be performed in a case of the work required status and indicating that there are a few targets for which a work is to be performed in a case of the work completion status.

8. The information processing system according to claim 2, wherein
the work area is an area in which autonomous traveling work machine performs a work, and
the status management unit determines a work completion timing at which the work for the work area has been completed by the autonomous traveling work machine transmitting the work completion timing in the work area to the status management unit.

9. The information processing system according to claim 2, wherein
a period setting table that associates at least one of a region of the work area, a season, a requirement for each region or individual factors for each region with the predetermined period with which the status of the work area is changed is provided, and
the status management unit determines the predetermined period for each work area based on the period setting table.

10. A control method of an information processor including a display terminal control unit that displays a map image on a display unit and acquires information regarding one or more work areas, in which
the display terminal control unit displays a work area image indicating a position of the work area and a status of the work area in a superimposed manner on the map image based on the acquired information, and
the status includes a work completion status corresponding to a condition during a predetermined period from a work completion timing at which a predetermined work for the work area has been completed and a work required status corresponding to a condition that requires the work after the predetermined period has elapsed.
